(19) United States
(12) Patent Application Publication
(10) Pub. No.: US 2025/0298195 A1
(43) Pub. Date: Sep. 25, 2025

(54) FIBER ASSEMBLY FOR COUPLING WITH PHOTONIC INTEGRATED CIRCUIT WITH LOW ALIGNMENT ERROR

(71) Applicant: nEye Systems, Inc., Emeryville, CA (US)

(72) Inventors: Ming Chiang A. Wu, Piedmont, CA (US); Benjamin N. Eldridge, Piedmont, CA (US)

(21) Appl. No.: 19/084,536

(22) Filed: Mar. 19, 2025

Related U.S. Application Data
(60) Provisional application No. 63/567,867, filed on Mar. 20, 2024.

(51) Int. Cl. G02B 6/42; G02B 6/32; G02B 6/35; G02B 6/36

(52) U.S. Cl. CPC G02B 6/4202; G02B 6/32; G02B 6/3548; G02B 6/3584; G02B 6/3636; G02B 6/4204; G02B 6/4227; G02B 6/4239

(57) ABSTRACT

The disclosed technology is generally directed to methods and structures for edge coupling between waveguides of a photonic integrated circuit (PIC) chip and an optical fiber array. The PIC may have a warpage caused by the PIC formed on a substrate. Some methods are directed to bending the optical fiber array to provide a bent optical fiber array having a curvature or warpage generally tracking that of the PIC chip. Some methods are directed to providing the bent optical fiber by application of mechanical force on the optical fiber array. Some methods and structures are directed to fabricating the optical fiber array having fiber core regions rotationally aligned with respect to an optical fiber mount to position centroids of the fiber core regions in a flat plane parallel to a major surface of the optical fiber mount.

### INCORPORATION BY REFERENCE TO ANY PRIORITY APPLICATIONS

This application claims benefit under 35 U.S.C. § 119(e) of U.S. Provisional Patent Application No. 63/567,867, entitled “FIBER ASSEMBLY FOR COUPLING WITH PHOTONIC INTEGRATED CIRCUIT WITH LOW ALIGNMENT ERROR” filed on Mar. 20, 2024, that is incorporated herein by reference in its entirety.

### BACKGROUND

### Field

The present disclosure is related generally to optical coupling between an optical fiber arrays and a waveguide, and more particularly to coupling between optical fibers and waveguides fabricated on a photonic integrated chip

### Description of the Related Art

The advent of monolithic fabrication techniques for fabrication of on-chip photonic devices and components has enabled fabrication of photonic integrated circuits (PICs) comprising a plurality of photonic devices of optically interconnected devices on a chip or substrate. A PIC used in an optical system can be in optical communication with another optical system, an optical sub-system, or an optical device. An optical connection between the PIC and another optical system or device may be established using edge coupling between a plurality of waveguides on the PIC and a plurality of optical fibers.

### SUMMARY

In some aspects, the techniques described herein relate to a photonic switch assembly, including: a photonic integrated circuit (PIC) including an array of optical waveguides formed on a PIC substrate, the optical waveguides terminating with waveguide facets at a side surface of the PIC; and an array of optical fibers disposed on a fiber substrate, the optical fibers terminating with fiber facets optically aligned with the waveguide facets, wherein the fiber facets and the waveguide facets have an alignment arrangement including: the optical fibers having differently positioned single mode zones such that centroids of the single mode zones have different radial distances from geometric centroids of the fiber facets, and the centroids of the single mode zones having substantially the same angular displacements relative to a plane corresponding to a major surface of the fiber substrate.

In some aspects, the techniques described herein relate to a photonic switch assembly, including: a photonic integrated circuit (PIC) including an array of optical waveguides formed on a PIC substrate, the optical waveguides terminating with waveguide facets at a side surface of the PIC, wherein the PIC substrate has a first curvature signature; and an array of optical fibers disposed on a fiber substrate, the optical fibers terminating with fiber facets optically aligned with the waveguide facets, wherein the fiber facets and the waveguide facets have an alignment arrangement including: the fiber substrate having a second curvature signature, wherein the second curvature signature generally tracks the first curvature signal, wherein the alignment arrangement has an alignment error that is lower relative to that of a reference alignment arrangement that is the same as the alignment arrangement, except that the fiber substrate does not have the second curvature signature.

In some aspects, the techniques described herein relate to a method of fabricating a photonic switch assembly, the method including: providing a photonic integrated circuit (PIC) including an array of optical waveguides formed on a PIC substrate, the optical waveguides terminating with waveguide facets at a side surface of the PIC, wherein the PIC substrate has a first curvature signature; providing an array of optical fibers disposed on a fiber substrate, the optical fibers terminating with fiber facets; bending the fiber substrate by applying a force on the fiber substrate to form a curved fiber substrate having a second curvature signature; disposing the array of optical fibers adjacent to the PIC to align waveguide facets with respective fiber facets, wherein a magnitude of misalignment between aligned ones of the waveguide facets and the respective optical fiber facets after bending is substantially smaller relative to a reference misalignment between the waveguide facets and the respective optical fiber facets prior to bending the fiber substrate; securing the bent fiber substrate to a substrate, after bending the fiber substrate, to maintain the second curvature signature in the absence of the force; and removing the force.

In some aspects, the techniques described herein relate to a method of fabricating a photonic switch assembly, the method including: providing a photonic integrated circuit (PIC) including an array of optical waveguides formed on a PIC substrate, the optical waveguides terminating with waveguide facets at a side surface of the PIC, wherein the PIC substrate has a first curvature signature; providing an array of optical fibers disposed on a fiber substrate, the optical fibers terminating with fiber facets; bending the fiber substrate by applying a force on the fiber substrate to form a curved fiber substrate having a second curvature signature; disposing the array of optical fibers adjacent to the PIC to align waveguide facets with respective fiber facets; wherein a magnitude of measured transmitted optical power of light transmitted through aligned ones of the waveguide facets and the respective optical fiber facets after bending is substantially higher relative to a reference transmitted optical power of a same light transmitted through the waveguide facets and the respective optical fiber facets prior to bending the fiber substrate; securing the bent fiber substrate to a substrate, after bending the fiber substrate, to prevent a change in the transmitted optical power in the absence of the force; and removing the force.

In some aspects, the techniques described herein relate to a method of fabricating a photonic switch assembly, the method including: providing an optical fiber mount having a first groove; placing a first optical fiber having a first core region within the first groove; rotating the optical fiber within the first groove to reduce a vertical offset of first core region with respect to a second core region of a second optical fiber mounted in second groove of the optical fiber mount; and securing the first optical fiber to the optical fiber mount to prevent further rotation of the first optical fiber with respect to the optical fiber mount.

### BRIEF DESCRIPTION OF THE DRAWINGS

In the following description of the various embodiments, reference is made to the accompanying drawings which form a part hereof, and in which is shown by way of illustration various embodiments of the device. It is to be understood that other embodiments may be utilized and structural changes may be made. It should be understood that the diagrams are not drawn in scale and certain dimensions may have been exaggerated for clarity and/or emphasis.

FIG. 1A is a schematic diagram showing a side view (top panel) and top view (bottom panel) of the edge portion of a photonic integrated circuit (PIC) die bonded to an electronic integrated circuit (EIC) forming a PIC-on-EIC stack, depicting a plurality of edge coupler waveguides and the corresponding edge coupler waveguide facets.

FIG. 1B is a schematic diagram showing a side view (top panel) and top view (bottom panel) of the edge portion of the PIC-on-EIC stack shown in FIG. Aligned with an optical fiber array for fiber-to-chip optical coupling.

FIGS. 1C-1D schematically illustrate two cross-sectional side views of an example of two-chip photonic integrated circuit (PIC) formed by two substrates. The two cross-sectional side views are rotated by 90 degrees with respect to each other.

FIGS. 1F-1E schematically illustrate a three-dimensional view (1E) and a side view (1F) of an example of two-chip photonic integrated circuit (PIC) bonded to an EIC and optically coupled to two optical fiber arrays.

FIG. 1G is a schematic diagram showing a top-view of an example integrated optical switch network including an optical switch matrix and two groups of bus optical waveguides connected to two groups of optical ports at two edges of the integrated optical switch network.

FIG. 2A is a schematic diagram showing side views of a warped PIC-on-EIC stack with a convex top surface (top panel), and the warped PIC-on-EIC aligned with an optical fiber array (bottom panel). The optical fiber facets are aligned to the edge waveguide coupler facets of the PIC chip for fiber-to-chip optical coupling (bottom panel).

FIG. 2B is a schematic diagram showing side views of a warped PIC-on-EIC stack with concave top surface (top panel), and the warped PIC-on-EIC aligned with an optical fiber array (bottom panel). The optical fiber facets are aligned to the edge waveguide coupler facets of the PIC chip for fiber-to-chip optical coupling.

FIG. 2C is a schematic diagram showing side views of a warped PIC-on-EIC stack with alternating convex and concave top surface regions (top panel), and the warped PIC-on-EIC with a fiber optical array aligned to the edge waveguide coupler facets of the PIC chip for fiber-to-chip optical coupling (bottom panel).

FIG. 3. is a schematic diagram showing a side view of the warped PIC-on-EIC depicting example regions of the warped PIC-on-EIC shown in FIG. 2C, which may be used to characterize the warpage for adjusting the position of the corresponding optical fibers.

FIG. 4A is a schematic diagram showing a top view of the edge portion of a PIC-on-EIC stack aligned with an array of optical fibers where an end facet of each optical fiber includes a microlens for efficient fiber-to-waveguide optical coupling.

FIG. 4B is a schematic diagram showing a top view of the edge portion of a PIC-on-EIC stack aligned with an array of optical fibers where a microlens is disposed on each edge coupler waveguide facet for efficient fiber-to-waveguide optical coupling.

FIG. 5A is a schematic diagram showing a side view of an optical fiber array structure including a fiber mount having a v-groove array with v-grooves having substantially identical depths and opening widths.

FIG. 5B is a schematic diagram showing a side view of a customized optical fiber array structure including a fiber mount having a v-groove array with v-grooves having tailored depths and opening widths for efficient optical coupling to a PIC with warpage.

FIG. 5C is a schematic diagram showing a closeup side view of an optical fiber positioned within a v-groove of a fiber mount depicting the width of the v-groove opening (w), the depth of the v-groove (d), the vertical offset (h) of the optical fiber (with respect to a top surface of the fiber mount), the core region of the optical fiber, and the center of the core region.

FIG. 6 is a schematic diagram showing a side view of a customized optical fiber array structure aligned with a warped PIC where individual v-grooves are tailored to align the optical fibers to the respective edge coupler waveguide facets of the PIC.

FIG. 7A is a schematic diagram showing a three-dimensional view of a flat optical fiber array optically aligned with a curved or warped PIC for fiber-to-chip optical coupling.

FIG. 7B is a schematic diagram showing a three-dimensional view of a mechanically bent optical fiber array optically aligned with a curved or warped PIC for fiber-to-chip optical coupling.

FIGS. 7C-7D show the bent optical fiber array shown in FIG. 7B secured to a substrate to maintain its curvature.

FIG. 8A is a schematic diagram showing a side view of an optical fiber array where core regions of individual optical fibers are randomly positioned with respect to specified positions associated with the respective grooves in an optical fiber mount.

FIG. 8B is a schematic diagram showing a side view of an optical fiber array where core regions of individual optical fibers are positioned in a single plane parallel to a major surface of an optical fiber mount.

FIG. 9 is a schematic diagram showing a three-dimensional view of a mechanically bent optical fiber array optically aligned with a curved or warped PIC for fiber-to-chip optical coupling prior to being stabilized. The core regions of the optical fibers are positioned in a single curved plane having substantially the same curvature of the optical fiber mount.

FIG. 10A-10C schematically illustrates the fabrication process of a bent optical fiber array comprising a thermal bending bilayer, showing cross-sectional views of the optical fiber array, before temperature change (A), after temperature change (B), and the resulting stabilized bent optical fiber array. The three-dimensional views of the optical fiber array aligned with a PIC before and after temperature changes are shown on the right sides of 10A and 10B, respectively.

FIG. 11A-11C schematically illustrates the fabrication process of a bent optical fiber array using a thermal bending layer, showing cross-sectional views of the optical fiber array, thermal bending layer, and the resulting bent composite structure.

### DETAILED DESCRIPTION

The advent of monolithic fabrication techniques for fabrication of on-chip photonic devices and components has enabled fabrication of photonic integrated circuits (PICs) comprising a plurality of photonic devices of optically interconnected devices on a chip or substrate. In some cases, an entire optical system or a portion of an optical system may be fabricated on one or more chips.

In some cases, a PIC may be mounted or bonded to an electronic integrated circuit (EIC), e.g., to provide electrical connection between an electronic circuitry of the EIC and one or more optical devices or components of the PIC (e.g., detectors, lasers, modulators, heaters, attenuators, or other electronic or optoelectronic devices). In some embodiments, the PIC may be bonded to EIC via a solder bump array or matrix configured to electrically connect one or more contact pads of the EIC to one or more contact pads of the PIC. In some cases, an EIC may comprise a complementary metal oxide semiconductor (CMOS) die. In some examples, a CMOS die may comprise one or more CMOS transistors that can form an electronic circuit.

While the optical components of a PIC can be optically interconnected via monolithically fabricated waveguides, in some cases, the PIC may receive and/or transmit optical signals from/to an optical system or device (e.g., an optical source, another PIC, a fiber coupled optical device, and the like). Fiber optic waveguides (also referred to as optical fibers) are commonly used to establish optical connection between a PIC and another optical device, optical system, or optical sub-system (e.g., low loss optical connection). As such, efficient optical coupling between optical fibers and a PIC can play an important role in the performance (e.g., power efficiency, signal-to-noise ratio, and the like) of an optical system comprising the PIC optically connected to another optical device or optical sub-system.

In some embodiments, fiber optic coupling to a PIC may comprise edge coupling one or more optical fibers (e.g., periodic or aperiodic optical fiber arrangements including an array) to the PIC via a facet of the PIC (herein referred to as edge-coupling facet). In some cases, a PIC may comprise optical waveguides (herein referred to as edge coupler waveguides) configured to optically connect one more optical devices and/or components of the PIC, to one or more optical fibers (e.g., periodic or aperiodic optical fibers of an arrangement including an optical fiber array) via the edge-coupling facet of the PIC. In some examples, an edge coupler waveguide can be extended from an optical device or waveguide formed on the PIC, to an edge region of the PIC. In some such examples, the edge coupler waveguide may be terminated by an edge coupler waveguide facet at or near the edge-coupling facet of the PIC. In some embodiments, the edge-coupling facet may be formed by cleaving (or cleaving and polishing) the PIC chip near output ends of the edge coupler waveguides. In some cases, the edge-coupling facet may comprise one or more edge coupler waveguide facets formed during the cleaving process. In some examples, an edge coupler waveguide facet may be formed prior to cleaving the PIC (e.g. by an etching process). An edge-coupling facet and/or the corresponding edge coupler waveguide facets may serve as one or both input and output optical ports of the PIC. In some cases, the edge-coupling facet and/or the corresponding edge coupler waveguide facets may be coated with an antireflection (AR) layer configured to reduce optical reflection from an interface between edge coupler waveguide facets and air gap between the edge-coupling facet and the fiber optic array. In some cases, the AR layer may comprise a plurality of sublayers having refractive indices and thickness configured to reduce optical reflection at the edge-coupling facet and/or the corresponding edge coupler waveguide facets within a specified wavelength range.

In some cases, the edge-coupling facet may comprise a surface region substantially perpendicular to a major surface of the PIC (e.g., a surface on which a photonic circuit is formed or a surface parallel to the surface on which a photonic circuit is formed). In some cases, the edge-coupling facet may be extended along a first direction parallel to the major surface (e.g., a flat or planar major surface) of the PIC or a plane corresponding to the major surface of the PIC chip. In some embodiments, a plurality of edge coupler waveguide facets can be arranged along the edge-coupling facet such that a vertical distance between edge coupler waveguide facets and the major surface of the PIC remains substantially constant along the edge-coupling facet. The vertical distance can be a distance along a second direction (e.g., a vertical direction) perpendicular to the major surface of the PIC chip or the plane corresponding to the major surface of the PIC chip. Such arrangement may facilitate optical alignment and coupling between the plurality of edge coupler waveguide facets and a plurality of optical fibers arranged such that the centers of all fiber cores are in a common plane (herein referred to as fiber array plane). For example, when the distances between consecutive edge coupler waveguide facets is matched to those of the respective fiber cores, all the fiber cores may be simultaneously aligned with the respective edge coupler waveguide facets by aligning one fiber core to an edge coupler waveguide facet and keeping the fiber array plane substantially parallel to the major surface of the PIC chip. In some examples, the plurality of edge coupler waveguide facets may comprise a periodic arrangement or periodic array having a pitch (e.g., waveguide facet-to-waveguide facet distance) equal to that of a periodic arrangement of optical fibers (e.g., a periodic fiber array) having the same pitch (e.g., fiber-to-fiber distance). In some other examples, the plurality of edge coupler waveguide facets and the plurality may not be periodic (e.g., it may comprise an aperiodic array) and the lateral positions of the edge coupler waveguide facets may be matched to those of a non-periodic or aperiodic arrangement of optical fibers (e.g., an aperiodic fiber array).

In some cases, a PIC may comprise two chips or substrates bonded together to provide optical and electrical connections between the electronic and/or photonic elements and components fabricated on different chips or substrates. Such PICs may be referred to as two-chip PICs. A two-chip PIC may include first and second plurality of edge coupler waveguide facets arranged along two different edges (e.g., two perpendicular edges) of the two-chip PIC. In some cases, the first and the second plurality of edge coupler waveguide facets can be formed on the same chip or substrate. In some cases, the first plurality of edge coupler waveguide facets can be formed on a first chip (e.g., a bottom chip) and the second plurality of edge coupler waveguide facets can be formed on a second chip (e.g., a top chip) bonded to the first chip. In some embodiments, a PIC may comprise a single chip comprising one or more plurality of edge coupler waveguide facets.

In some cases, during or after fabrication, a PIC (or the wafer on which the PIC is fabricated) may be deformed or warped, e.g., due to process-stress, or mismatch between physical properties of different layers, and the like. In some cases, the warpage may be caused by different stress levels in different materials, different thermal expansion of different materials, and nonideality in the fabrication processes of the PIC. In some cases, where the PIC is bonded to a warped EIC (e.g., a CMOS die), the warpage of the EIC may cause the warpage of the PIC. In some other cases, nonideality in the PIC-on-EIC bonding process may cause the warpage of the PIC and EIC. As such in some cases, a flat PIC may become warped after bonding to an EIC or other substrates (e.g., carrier substrates).

Such warpage may cause the edge coupler waveguide facets to be displaced with respect to each other along the vertical direction perpendicular to a plane (e.g., a non-warped surface) corresponding to a major surface of the warped PIC. Such displacement may reduce the optical coupling between some of the edge coupler waveguides and respective optical fibers of an optical fiber array having a flat fiber array plane. In some cases, when the PIC is warped, the plane corresponding to it major surface can be a plane perpendicular to at least two cleaved facets of the PIC extended along two different directions, and the vertical direction can be a direction perpendicular to that plane.

Some embodiments of this disclosure are directed to edge coupling between waveguides of a photonic integrated circuit (PIC) chip, e.g., a single chip or a two-chip PIC, and an optical fiber array when the PIC has warpage. Some of the methods are directed to measuring displacements of edge coupler waveguide facets (e.g., with respect to a nominal plane corresponding to a major surface of the PIC), due to PIC chip warpage. Some methods and structures are directed to customized optical fiber array structures having fiber cores positioned based on the measured displacements for the edge coupler waveguide facets to improve the optical coupling efficiency between the individual edge coupler waveguide facets and the optical fibers. Some embodiments may use a microlens array between the integrated circuit (PIC) chip and the optical fiber array to improve optical coupling. In various implementations, the microlens array may be disposed on the core regions of the individual optical fiber facets or on the individual edge coupler waveguide facets.

In some embodiments, the PIC chip (or a chip of a two-chip PIC) may comprise a substrate and a waveguide layer disposed on the substrate. In some embodiments, the edge coupler waveguides may be fabricated on or within the waveguide layer. In some examples, the substrate may comprise silicon (e.g., a silicon wafer). In some examples, the waveguide layer may comprise silicon dioxide (SiO₂). In some examples, an edge coupler waveguide may comprise silicon nitride (SiN). In some embodiments, the PIC chip may comprise a waveguide layer comprising SiN edge coupler waveguides embedded in a silicon dioxide layer (also referred to as a cladding layer) disposed on a silicon substrate. In some embodiments, the PIC chip may comprise a waveguide layer comprising silicon edge coupler waveguides embedded in a silicon dioxide layer (also referred to as a cladding layer) disposed on a silicon substrate. In some other embodiments, the edge coupler waveguides, the substrate, and/or the cladding layer may comprise other materials.

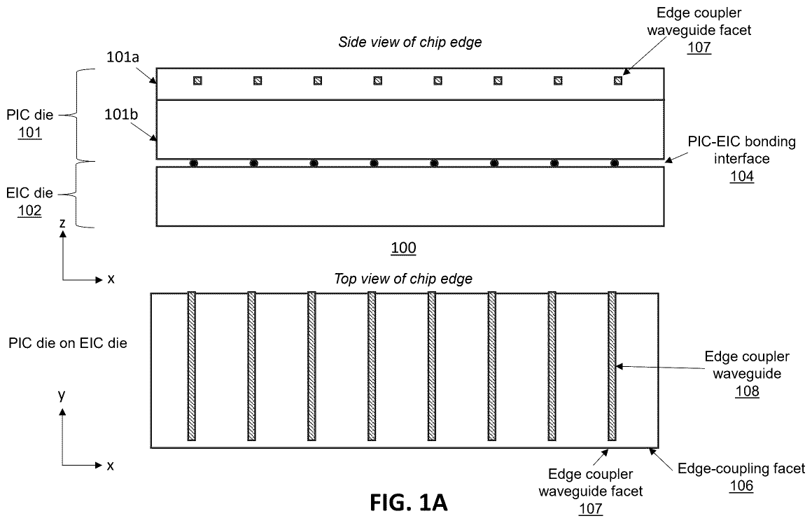

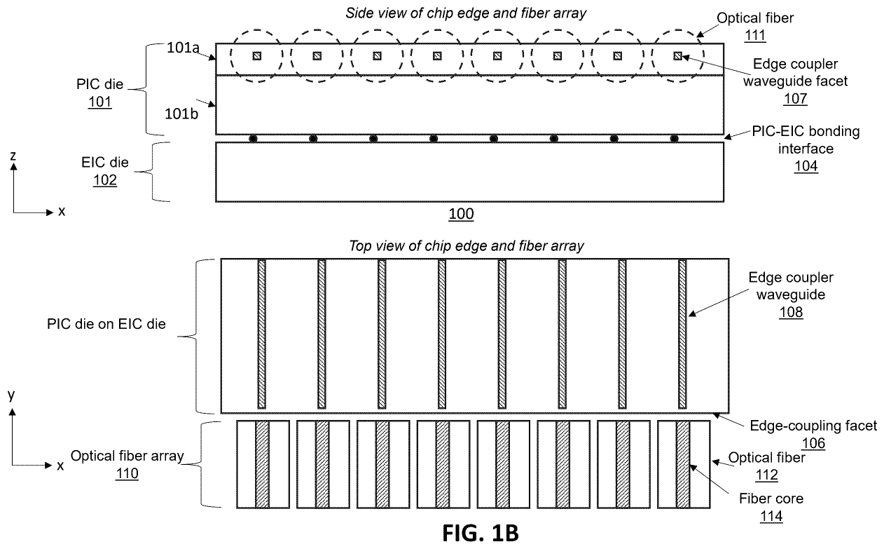

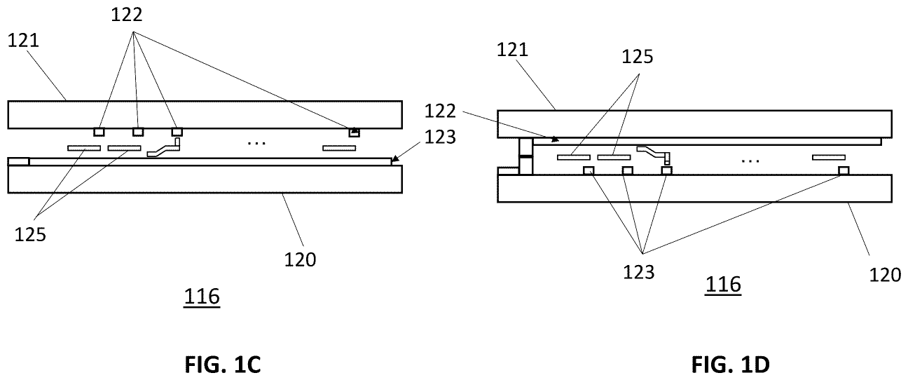

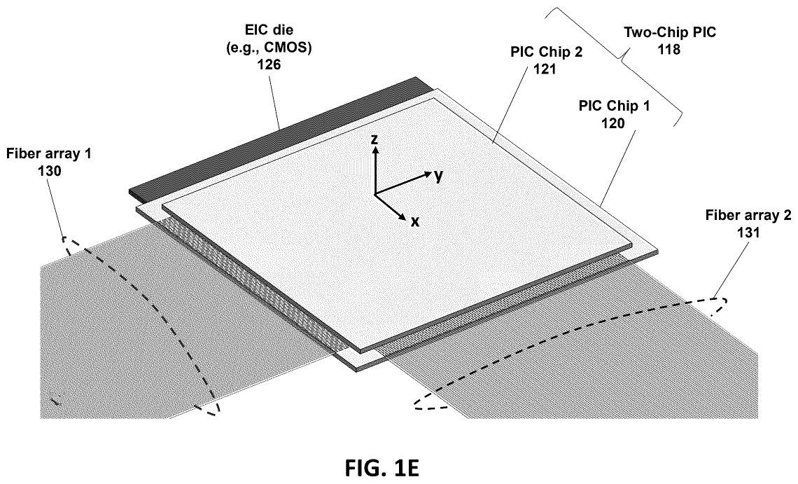

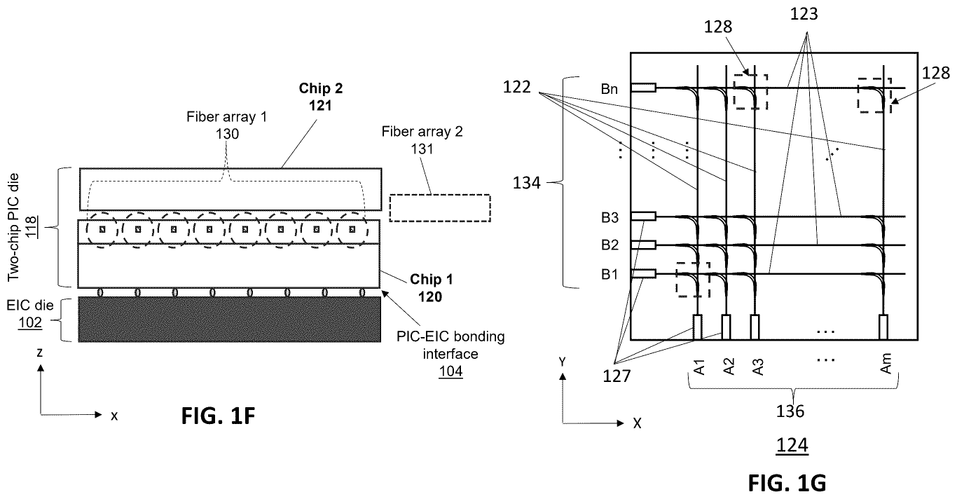

FIG. 1A. is a schematic diagram showing a side view (top panel) and a top view (bottom panel) of an edge portion (or region) of a photonic integrated circuit (PIC) die 101 (or PIC 101) stacked on or above, e.g., bonded to, an electronic integrated circuit (EIC) die 102 (or EIC 102) depicting a plurality of edge coupler waveguides and the corresponding edge coupler waveguide facets. In some embodiments, the PIC 101 may be bonded to the EIC 102 via a bonding interface 104 to form a composite structure herein referred to as a PIC-on-EIC stack 100. In some cases, the bonding interface 104 may comprise a solder bump array or matrix. In some cases, the EIC 102 may comprise a complementary metal-oxide-semiconductor (CMOS) die including CMOS transistors in electrical communication with the PIC 101 (e.g., for controlling, monitoring, or otherwise exchange electrical signals with photonic elements of the PIC 101).

The PIC 101 may comprise a waveguide layer 101a within which one or more edge coupler waveguides are embedded. The waveguide layer 101a may be fabricated on a substrate 101b. In some examples, the waveguide layer 101a may comprise silicon dioxide and the substrate 101b may comprise silicon. In some embodiments, an edge coupler waveguide 108, and the corresponding edge coupler waveguide facet 107, may have a thickness (e.g., along z-axis) from 200 nm to 350 nm, 350 nm to 400 nm, or other thicknesses, and a width (e.g., along x-axis) in the range of 100 nm to 300 nm, or other widths. In some embodiments, the edge coupler waveguide facets may form a periodic array of facets having a pitch from 100 to 127 microns, from 127 to 250 microns, or larger or smaller values. In some cases, the corresponding edge coupling waveguide array can be a periodic waveguide array with the same or different pitch compared to the periodic array of facets. For example, at least a portion of the periodic waveguide array can have a pitch different (e.g., smaller) than the pitch of the periodic array of facets. In some embodiments, lateral positions of at least a portion of the edge coupler waveguide facets may not be periodic.

In some embodiments, the PIC 101 may comprise an edge-coupling facet 106 extended in a first direction (e.g., along x-axis) parallel to a top major surface 105 of the PIC 101 and the plurality of edge coupler waveguide facets can be arranged along the edge-coupling facet 106 such that a vertical distance (e.g., along z-axis) between edge coupler waveguide facets (shown as small squares) and the top major surface 105 of the PIC 101 remains substantially constant along the first direction (e.g., x-axis). The vertical distance can be a distance along a second direction (e.g., parallel to z-axis). In some cases, the second direction can be substantially orthogonal to the first direction. As such in the example shown, the PIC die 101 and the EIC (CMOS) die 101 are flat and the edge coupler waveguide facets are located on a flat plane parallel to the x-y plane and perpendicular to z-axis. Since the PIC 101 is not warped, in this case the top major surface 105 of the PIC 101 is can be plane with respect to which the vertical direction is defined and the vertical positions of the edge coupler waveguide facets are measured or determined.

FIG. 1B is a schematic diagram showing a side view (top panel) and top view of (bottom panel) the edge portion of the PIC-on-EIC stack 100 shown in FIG. 1A aligned with an optical fiber array 110 for fiber-to-chip optical coupling. An individual optical fiber 112 of the optical fiber array 110 may comprise a core region 114 (also referred to as fiber core) surrounded by a cladding where light substantially resides within the fiber core 114 and is guided through the fiber core 114. In some examples, the optical fiber array 110 may comprise a plurality of optical fibers positioned such that the centers of the corresponding fiber cores are substantially within a flat plane parallel to top major surface of the PIC 101 or a top surface of a fiber mount on which the optical fiber array is formed (e.g., parallel to x-y plane). Since the edge coupler waveguide facets are located on a flat plane (parallel to x-y plane), when the optical fibers and the edge coupler waveguide facet are uniformly (e.g., periodically) spaced in a lateral direction (e.g., along the x-axis) with the same pitch, each fiber core 114 can be aligned with the respective edge coupler waveguide facet 107 to provide efficient fiber-to-waveguide coupling. While in the examples shown in FIGS. 1A and 1B the edge coupler waveguide facets of the PIC 101 are periodically positioned along the lateral direction, the embodiments are not so limited and, in some cases, the lateral positions of the edge coupler waveguide facets of a PIC may not be periodic along the lateral direction. In these embodiments the lateral positions of the optical fibers of an optical fiber array optically coupled to the edge coupler waveguide facets may match the lateral positions of the edge coupler waveguide facets and thereby may not be periodic along the lateral direction.

FIGS. 1C-1D schematically illustrate two cross-sectional side views of an example of two-chip PIC 116 formed by two substrates or chips 120, 121. The two cross-sectional side views are rotated by 90 degrees with respect to each other. In some embodiments, the two-chip PIC 116 may be formed by bonding (e.g., flip-chip bonding) of a first chip 120 to a second chip 121. The first chip 120 may comprise a first plurality of bus optical waveguides 123 and the second chip 121 may comprise a second plurality 125 of bus optical waveguides. The first and second plurality of bus optical waveguides 123, 125 may be optically coupled to a first and second plurality of edge couplers respectively. In some examples, the first plurality of edge couplers may be configured to optically couple the first plurality of bus optical waveguides 123 to a first plurality of external waveguides (e.g., the optical fibers in an first optical fiber array) and the second plurality of edge couplers may be configured to optically couple the second plurality of bus optical waveguides to a second plurality of external waveguides (e.g., the optical fibers in a second optical fiber array). In some embodiments, the two-chip PIC 116 may include a plurality of optical switches configured to controllably couple one or more optical bus waveguides of the first plurality of bus optical waveguides 123 to one or more optical bus waveguides of the second plurality of bus optical waveguides 125.

FIGS. 1E-1F schematically illustrate a three-dimensional view (FIG. 1E) and a side view (FIG. 1F) of an example of two-chip photonic integrated circuit (PIC) die 118 optically coupled to two optical fiber arrays 130, 131. The two-chip PIC 118 can be bonded to an electronic integrated circuit (EIC) die 102 (or EIC 102). The two-chip PIC 118 may comprise first and second plurality of edge optical waveguide couplers and the corresponding edge coupler waveguide facets. In some embodiments, the two-chip PIC 118 may be bonded to the EIC 126 via a bonding interface (e.g., similar to the bonding interface 104) to form the PIC-on-EIC stack shown in FIGS. 1E and 1F. The EIC 126 may be flip-chip bonded to the lower PIC chip 120. In some cases, the bonding interface may comprise a solder bump array or matrix. In some cases, the EIC 126 may comprise a complementary metal-oxide-semiconductor (CMOS) die having control circuitry in electrical communication with each PIC chip the two-chip PIC 118 (e.g., for controlling, monitoring, or otherwise exchange electrical signals with photonic elements on the two-chip PIC 118). In some implementations, the upper PIC chip 121 may be configured to receive control signals directly through one or more through-substrate vias (TSVs) formed through the lower PIC chip 120.

In some embodiments the two-chip PIC 118 may comprise one or more features described above with respect to the two-chip PIC 118. In some examples, the two-chip PIC 118 may comprise a first (lower) PIC chip or substrate 120 and a second (upper) PIC chip or substrate 121 where one or both chips or substrates 120, 121, may comprise one or more features described above with respect to the PIC 101.

In some embodiments, the two-chip PIC 118 may comprise a first plurality of edge-coupling facets extending in a first direction (e.g., along x-axis) substantially parallel to a top major surface of the first and/or second chip or substrates 120, 121 and a second plurality of edge-coupling facets extending in a second direction (e.g., along y-axis) substantially parallel to the top major surface of the first and/or second chip or substrates 120, 121. In some cases, the first and second directions can be substantially perpendicular to each other or form an angle different from 90 degrees.

In the example shown in FIGS. 1E and 1F, the first plurality of edge-coupling facets are optically aligned with the optical fibers of a first optical fiber array 130 and the second plurality of edge-coupling facets are optically aligned with the optical fibers of a second optical fiber array 131.

In some embodiments, one or both first and second pluralities of edge coupler waveguide facets can be arranged such that a vertical distance between the edge coupler waveguide facets and the top major surface of the corresponding chip of the two-chip PIC 118 remains substantially constant. In some cases, a major surface of a chip of the two-chip PIC 118 may be curved, warped, or otherwise deformed, such that at least two edge coupler waveguide facets are positioned at different vertical distances relative to the top major surface of the corresponding chip. In some examples, when the two-chip PIC 118 is curved, warped, the vertical distances between the edge coupler waveguide facets and the top major surface of the corresponding chip may comprise a curvature or warpage similar to that of the two-chip PIC 118. In some cases, a single chip PIC (e.g., a PIC die) may comprise first and second pluralities of edge coupler waveguides each arranged along a different edge of the single PIC chip. In some cases, the first and second pluralities of edge coupler waveguides of the single chip PIC may be optically coupled to the first and second optical fiber arrays 130, 131.

In some embodiments, a single chip or a two-chip PIC may comprise an integrated optical switch network configured to controllably couple individual bus optical waveguides of first and second plurality of bus optical waveguides may be both formed on the single chip, or each formed on a different chip of the two-chip PIC. In some embodiments, the integrated optical switch network may comprise one or more microelectromechanical systems (MEMS) optical switches.

In some cases, the first and second plurality of bus optical waveguides may be aligned and optically coupled to the first and second plurality optical fiber arrays 130, 131. FIG. 1G is a schematic diagram showing a top-view of an example of such integrated optical switch network 124 comprising first and second pluralities of bus optical waveguides 122, 123, and a plurality of optical switches 128 configured to controllably couple individual bus optical waveguides of first and second plurality of bus optical waveguides 122, 123. In some embodiments, an optical switch of the plurality of optical switches 128, may comprise a MEMS optical switch, where the MEMS optical switch comprises a shunt waveguide configured to controllably couple a bus optical waveguide of first plurality of bus waveguides 122 to a bus optical waveguide of the second plurality of bus waveguides 123. The first and second pluralities of bus optical waveguides 122, 123 can be optically connected to first and second pluralities of edge couplers 136, 134, respectively. In some cases, the integrated optical switch network 124 may comprise the two-chip PIC die 118 or a single-chip PIC such as the PIC die 116.

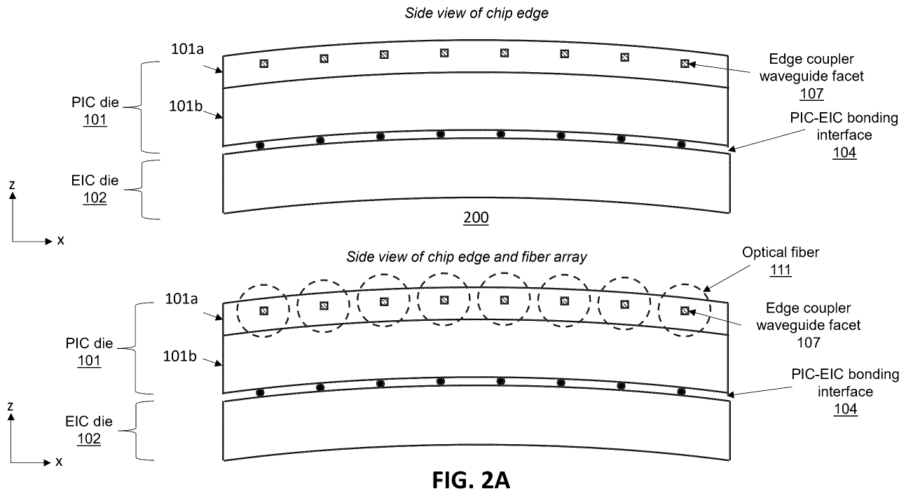

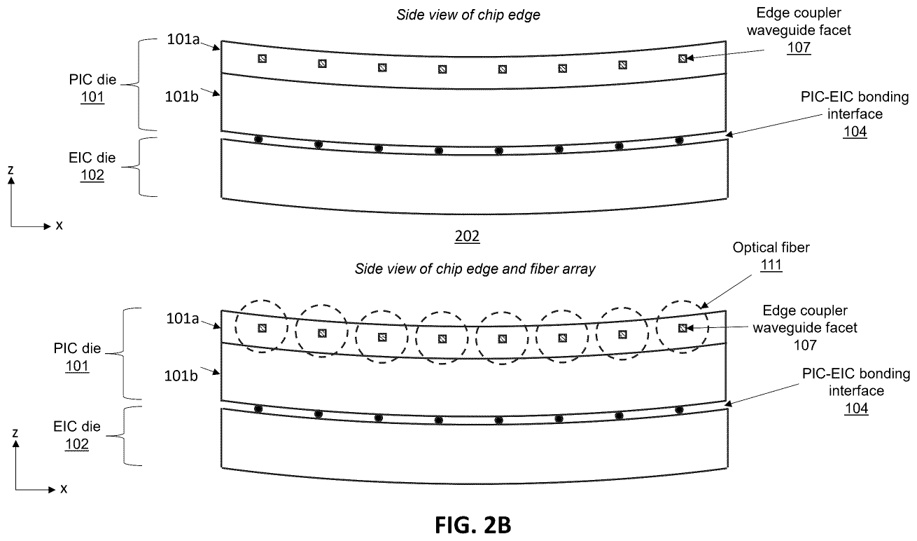

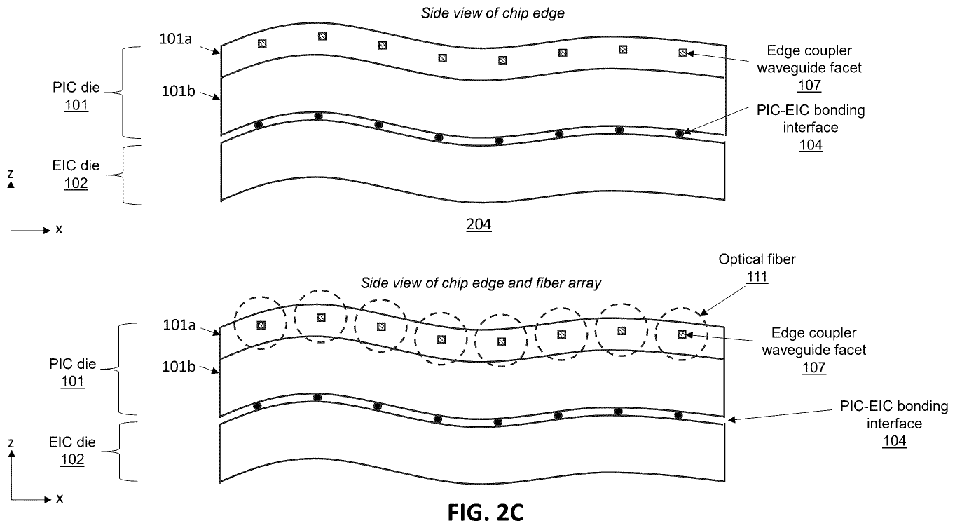

As mentioned above, in practice, a PIC and/or the CMOS dies may have curvature and/or warpage. The curvature and/or warpage may be in a single direction as shown in FIGS. 2A and 2B, or comprise a pattern (e.g., a random pattern or a periodic pattern) as shown in FIG. 2C. Independent of the warpage and/or curvature direction or profile, when the PIC die 101 or the two-chip PIC 118 is warped and/or curved, the edge coupler waveguide facets can be no longer located on a flat plane. As such, when the fiber cores of an optical fiber array are in a flat plane, efficient coupling between substantially all, or at least a majority of, the optical fibers of the optical fiber array and substantially all, or at least the majority, of the edge coupler waveguide facets may be difficult. In some cases, to achieve efficient optical coupling between the optical fibers of an optical fiber array and edge coupler waveguide facets of a warped and/or curved PIC, and/or provide substantially the same optical coupling between different optical fiber-edge coupler waveguide facet pairs, the optical fibers may be arranged such that the corresponding fiber cores form a non-flat pattern (e.g., a warped plane) that matches with the warpage and/or curvature of the edge coupler waveguide facets and thereby enables optical alignment between all, or majority, of the edge coupler waveguide facets and the respective optical fibers. Some methods disclosed herein may comprise, tailoring the positions or relative positions of the optical fibers of an optical fiber array along a vertical direction perpendicular to a major surface a fiber mount on which the optical fiber array is formed (e.g., along z-axis) according to relative vertical displacements of the respective edge coupler waveguide facets of a PIC die or two-chip PIC that is warped, curved, or deformed. In some embodiments, tailoring the positions of the optical fibers of the optical fiber array may comprise tailoring the individual grooves of the fiber mount. In some embodiments, tailoring the positions of the optical fibers of the optical fiber array may comprise mechanically deforming the fiber mount to match the positions of the optical fibers to the edge coupler waveguide facets.

In some embodiments, when the PIC of a PIC-on-EIC comprises a two-chip PIC 118, e.g., the PIC-on-EIC stack shown in FIGS. 1E-1F, the first (lower) PIC chip 120 of the two-chip PIC 118, which may comprise one or more through-substrate or through-silicon vias (TSVs), can be bonded to the EIC die 102, and then the second (upper) PIC chip 121 of the two-chip PIC may be bonded or otherwise attached to the first chip 120 to form the PIC. In some other embodiments, when the PIC of a PIC-on-EIC comprises a two-chip PIC 118, e.g., the PIC-on-EIC stack shown in FIGS. 1E-1F, the first PIC (lower) chip 120, which may comprise TSVs, may be bonded or otherwise attached to the second (upper) PIC chip 121 to form the two-chip PIC 118, which may in turn be bonded to the EIC die 102.

In various embodiments, The EIC die 102 may comprise a CMOS circuit having a plurality of conductive contact pads. In some examples, a portion of the conductive contact pads may be arranged according to an arrangement of at least a portion of the TSVs of the first chip 120.

In some embodiments, bonding the PIC or the first PIC chip 120 to the EIC die 102 may comprise flip-chip bonding and connecting the TSVs of the first PIC chip 120 to the respective conductive pads of the EIC die. In some embodiments, bonding the PIC or the first PIC chip 120 to the EIC die 102 may further comprise wire bonding some of the conductive contact pads of the EIC die 102 to a carrier substrate (e.g., a printed circuit board such as a ceramic printed circuit board).

In some embodiments, the first and second PIC chips 120, 121, may be provided by fabricating respectively on first and second wafers, which may comprise multiple chips, dicing the first wafer to provide the first PIC chip 120, and dicing the second wafer to provide the second PIC chip 121. In some embodiments, the assembly of the first PIC chip 120 and the second PIC chip 121 is performed with the EIC die 102 bonded, e.g., flip-chip bonded, to the first PIC chip 120. In other embodiments, the EIC die 102 is bonded, e.g., flip-chip bonded, to the first PIC chip 120 subsequent to the assembly of the first PIC chip 120 and the second PIC chip 121.

FIG. 2A is a schematic diagram showing side views of a nonlimiting example of a warped PIC-on-EIC stack 200 (top panel) comprising a warped PIC 201 with a convex top major surface 209a, and the warped PIC-on-EIC stack 200 aligned with a customized optical fiber array 210 (bottom panel). The edge coupler waveguide facets of the warped PIC 201 are aligned with the fiber cores of the customized optical fiber array 210 to provide fiber-to-chip optical coupling

FIG. 2B is a schematic diagram showing side views of another nonlimiting example of a warped PIC-on-EIC stack 202 (top panel) comprising a warped PIC 201 with a concave top surface 209b, and the warped PIC-on-EIC 202 aligned with a customized optical fiber array 212 (bottom panel). The edge coupler waveguide facets of the warped PIC 201 are aligned with the fiber cores of the customized optical fiber array 212 to provide fiber-to-chip optical coupling.

FIG. 2C is a schematic diagram showing side views of yet another nonlimiting example of a warped PIC-on-EIC stack 204 (top panel) comprising a warped PIC 201 with a warped top surface 209c having alternating convex and concave regions, and the warped PIC-on-EIC stack 204 aligned with a customized optical fiber array 214 (bottom panel). The edge coupler waveguide facets of the warped PIC 204 are aligned with the fiber cores of the customized optical fiber array 214 to provide fiber-to-chip optical coupling (bottom panel).

In some embodiments, a method of designing and forming an optical fiber array for optical coupling to coupler waveguides of a warped PIC (e.g., PICs in the PIC-on-EIC stacks 200, 202, 204) may comprise characterizing the warpage of the warped PIC or the warpage profile (z-displacement profile along x-axis also referred to height profile) of the corresponding edge coupler waveguide facets.

In some embodiments, a warped PIC may comprise a plurality of edge coupler waveguide facets that their relative vertical positions varies along the lateral direction by more than 2%, more than 4%, more than 6%, more than 8%, or more than 10% of an average vertical position the plurality of edge coupler waveguide facets, where the vertical position is measured with respect to a plane corresponding to a major surface of the warped PIC (e.g., plane 213 corresponding to top major surfaces 209a-c), and the vertical direction (e.g., z-direction) being perpendicular to the plane. In some embodiments, the warpage profile may comprise a variation of the vertical positions along the lateral direction (e.g., along the x-axis).

In various implementations, different portions, regions, facets, or surfaces of a warped PIC may be measured to determine the warpage profile. For example, a surface profile of the PIC 204 (e.g., the profile the warped top major surface 209c) may be measured (e.g., using an optical or stylus based profilometer). The surface profile may be used to determine the warpage profile of the edge coupler waveguide facets (e.g., variation of the positions of the edge coupler waveguide facets along z-axis). In some embodiments, the warpage profile of the edge coupler waveguide facets may be determined by measuring (e.g., using imaging) the profile of the interface between the waveguide layer 101a and the substrate 101b. In some embodiments, the warpage profile of the edge coupler waveguide facets may be determined by directly imaging the edge coupler waveguide facets.

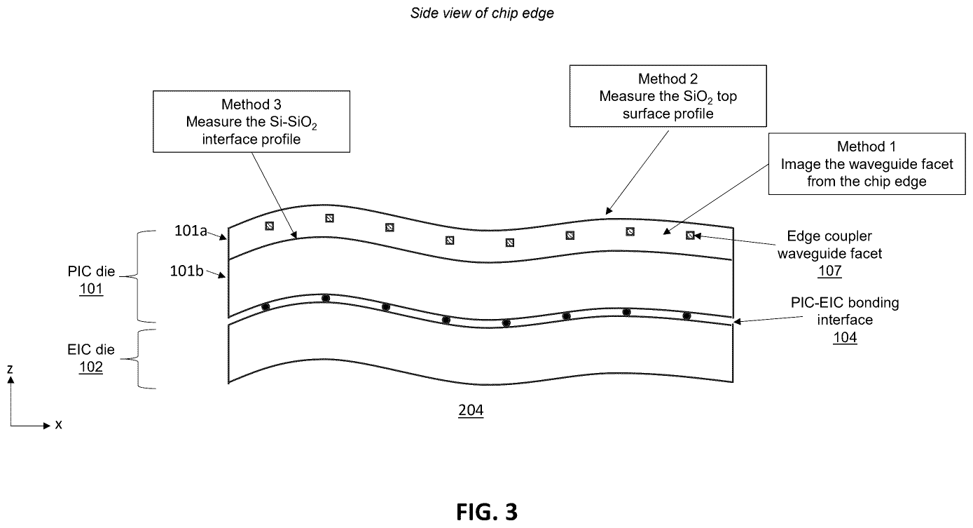

FIG. 3 is a schematic diagram depicting example regions of the warped PIC-on-EIC stack 204 shown in FIG. 2C, which may be measured using three different methods described below to determine the warpage profile of the corresponding edge coupler waveguide facets. In various implementations, geometrical features of one or more of these regions may be directly proportional to the warpage profile of the edge coupler waveguide facets or may be used to estimate or calculate the warpage profile of the edge coupler waveguide facets. In some examples, the warpage profile of the edge coupler waveguide facets may comprise variation of vertical distances of edge coupler waveguide facets with a respect to a flat plane.

Method 1: In some embodiments, a chip facet of the PIC 204 may be imaged by a microscope. For example, the edge coupling waveguide facet of the PIC 204 may be imaged, and individual edge coupler waveguide facets may be identified in the microscopic image. In some examples, an edge coupler waveguide facet may be identified using a digital image processing method. In some cases, once the edge coupler waveguide facets are identified, relative locations (relative vertical variations or displacements) of the identified waveguide facets may be measured from the image, e.g., to generate the warpage profile 216. In some examples, warpage profile of the edge coupler waveguide facets may comprise z-coordinates of different waveguide edge coupler waveguide facets (e.g., a center of a waveguide facet) distributed along x-axis.

Method 2: In some embodiments, it may be considered that the warpage of a plane defined by the edge coupling waveguides (silicon nitride (SiN) waveguides) is approximately or substantially the same as the warpage of the top surface of the warped PIC die 201. In some such embodiments, the profile of the top surface of warped PIC 201 (or the top surface 218 of the waveguide layer 201a, e.g., an SiO₂ layer) may be measured by a surface profiler. Subsequently, the vertical offset of each edge couple waveguide facet can be calculated or extracted from the measured warpage of the top surface of the waveguide layer at the corresponding lateral position (e.g., along x-axis).

Method 3: In some embodiments, it may be considered that the warpage profile of a plane defined by the edge coupling waveguides (SiN waveguides) is approximately or substantially the same as the warpage profile of the interface 220 between the waveguide layer 201a and the substrate 201b (Si—SiO₂ interface) of the warped PIC 201. In some cases, the warpage profile of the interface 220 between the waveguide layer 201a and the substrate 201b interface can be measured by a profiler and/or imaging system. In some cases, the vertical offset of individual edge coupler waveguide facets (along z-axis) can be calculated or extracted from the measured warpage of the Si—SiO₂ interface at the corresponding lateral position (position along x-axis). In some embodiments, the warpage profile of the PIC may be measured by measuring a vertical variation profile of the interface 220 between the waveguide layer 201a and the substrate 201b.

In some embodiments, a warped PIC may comprise a warpage or warpage profile that can be measured, characterized, or quantified using one the method described above or other methods. In some embodiments, the warped PIC may comprise a warped interface, a warped surface, or a nominal warped path or line defined by an edge coupler waveguide facets. In some examples, vertical positions of laterally separated points (e.g., along x-axis) on the warped interface, the warped surface, the warped path may vary by a percentage of an average vertical position of the laterally separated points that can range from 2% to 4%, form 4% to 6%, from 6% to 8%, from 8% to 10%, from 10% to 20% or a range defined by any of these values. In some cases, the vertical position can be measured with respect to a plane corresponding to a major surface of the warped PIC (e.g., plane 213 corresponding to top major surfaces 209a-c), where the vertical direction (e.g., z-direction) can be perpendicular to the plane.

Once the warpage profile of a warped PIC is measured or determined (e.g., using one of the methods described above or other methods), the measured/determined warpage profile may be used to determine the positions (e.g., vertical positions) of individual optical fibers in the optical fiber array. In some embodiments, after determining the positions of the individual optical fibers, a customized optical fiber array comparison fiber facets having tailored vertical positions may be fabricated by fabricating a customized fiber mount and mounting the individual optical fibers on the customized fiber mount (e.g., a v-groove array) configured to provide the tailored and customized relative vertical displacements for different optical fibers of the customized optical fiber array. Such customized and/or tailored optical fiber positioning (according to the measured edge coupler waveguide facet locations or the measured warpage profile of the PIC) can facilitate and improve optical coupling efficiency between individual edge coupling waveguides and the respective optical fibers.

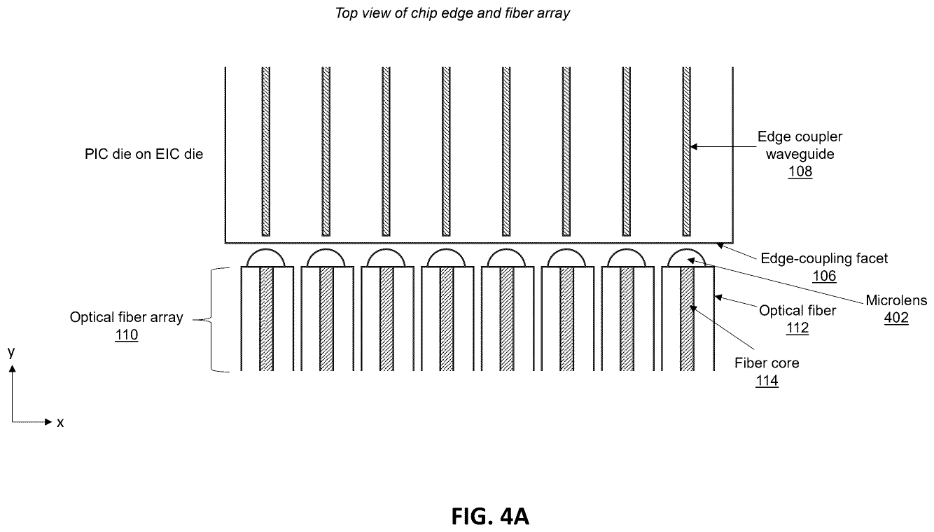

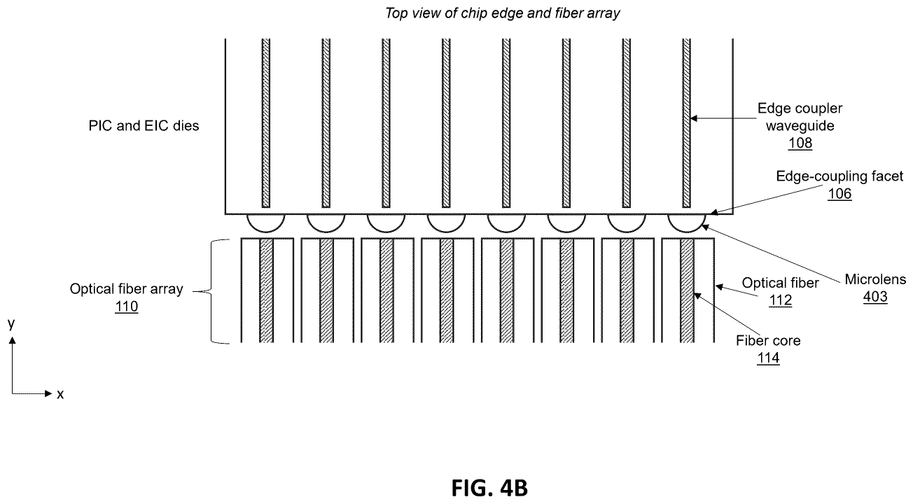

In some embodiments, one or more microlenses may be disposed on corresponding one or more facets of an optical fiber array (e.g., the optical fiber array 110, or the customized optical fiber arrays 210, 212, or 214) or on corresponding one or more of the edge coupler waveguide facets of a PIC chip (e.g., the flat PIC 101, or the warped PIC 201 in FIGS. 2A, 2B, and 2C) to improve optical coupling efficiency between the individual optical fibers and he respective edge coupling waveguides. FIG. 4A is a schematic diagram showing a top view of the edge portion (or region) of a PIC-on-EIC stack aligned with an array of optical fibers where microlenses are disposed or formed on end facets of individual optical fibers to improve fiber-to-waveguide optical coupling. FIG. 4B is a schematic diagram showing a top view of the edge portion (or region) of a PIC-on-EIC stack aligned with an array of optical fibers where microlenses are formed or disposed on individual edge coupler waveguide facets for efficient fiber-to-waveguide optical coupling.

In some examples, with reference to FIG. 4A, a microlens 402 may be disposed on a facet of an optical fiber 112 and over core region 114 of the fiber 112 to match an optical mode profile (e.g., mode size) of the optical fiber 112 to an optical mode profile (e.g., mode size) of the corresponding edge coupler waveguide 108. In some examples, with reference to FIG. 4B, a microlens 403 formed or disposed on an edge-coupling facet 106 may be configured to match an optical mode profile (e.g., mode size) of the edge coupler waveguide 108 to an optical mode profile (e.g., mode size) of corresponding optical fiber 112.

In some implementations, the microlenses may be attached, 3D printed, or fabricated (e.g., using UV curing) on the PIC chip facet or the fiber array facet. In some cases, an end region of an optical fiber close to the edge-coupling facet 106 may be shaped (e.g., tapered) to form a lens. For example, the optical fiber can be cleaved and then tapered by wet etching or thermal treatment. In some other embodiments, an optical fiber of the optical fiber array may comprise a numerical aperture (e.g., high numerical aperture) configured such that a size (e.g., a beam waist) of the beam transmitted via the optical fiber is matched to the mode size of a respective edge coupler waveguide.

Some embodiments disclosed herein may provide structures for fabricating an optical fiber array having a vertical displacement profile matched to that of the edge coupler waveguide facets of a PIC to which the optical fiber array may be coupled. In some embodiments, these structures may comprise fiber mounting substrates configured for positioning and stabilizing (e.g., mechanically stabilizing) the optical fibers of the optical fiber array according to a measure warpage profile of the corresponding PIC (e.g. the warpage profile of the edge coupling waveguide facets of the PIC).

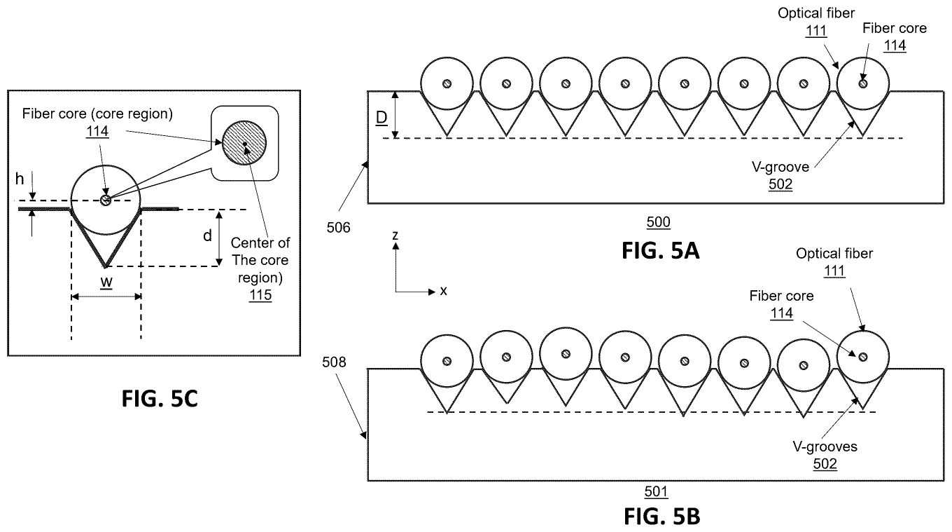

FIG. 5A is a schematic diagram showing a side view of optical fiber array structure 500 fabricated on an optical fiber mount 506 (also referred to as fiber mount) with a v-groove pattern or array. In some examples, the optical fiber mount 506 may comprise a patterned fiber substrate comprising a plurality of grooves such as V-shaped grooves (herein referred to as v-grooves), or grooves have other shapes (e.g., cross-sectional shapes) such as rectangular, circular, elliptical and the like. In some embodiments, the fiber substrate or a fiber mount may comprise any mounting structures configured to position and stabilize the optical fibers. In some embodiments, the fiber mount may comprise a plurality of v-grooves (e.g., a periodic or aperiodic arrangement of v-grooves or an array of grooves), where an individual v-groove 502 comprises an opening width and opening depth (e.g., etch depth). In some cases, the vertical position of an individual optical fiber 112, and thereby its core region 114 (e.g., with respect to a flat top or bottom surface of the optical fiber mount 506) may depend on the opening width of the corresponding v-groove 502. In the example shown, the optical fiber mount 506 comprises an array of v-grooves having substantially equal depths (D) and equal opening widths. In some cases, the v-grooves of the optical fiber array structure 500 may position the optical fibers such that centers of their core regions are located in a flat plane (e.g., parallel to a flat top or bottom surface of the optical fiber mount 506). In some examples, the optical fiber mount 506 may comprise v-grooves formed in a silicon or glass block; however, the embodiments are not so limited, and v-grooves may be formed on substrates composed of other materials (such as other semiconductors, other crystalline materials, metals, ceramics, polymers, and the like). In the example shown, the v-grooves are uniformly (e.g., periodically) distributed along x-axis. In some implementations, the optical fiber array v500 can be optically coupled to a flat PIC having edge coupling waveguide facets positioned along a straight line parallel to a major surface of the PIC (e.g., the optical fiber array structure 500 may comprise the optical fiber array 110 in FIG. 1B optically coupled to the PIC 101).

In some cases, when the optical fiber array structure 500 is aligned to a warped PIC (e.g., warped PIC 201), some of the optical fibers may not be optically coupled to the respective edge coupler waveguides with sufficient efficiency. In some embodiments disclosed herein, one or both opening width and opening depth of individual v-grooves of a customized optical fiber mounting structure may be tailored according to a determined z-displacement of the optical fiber placed in the v-groove. In some cases, the z-displacement of the optical fiber may be determined based at least in part on a measured warpage profile of the PIC.

FIG. 5B is a schematic diagram showing a side view of a customized optical fiber array structure 501 fabricated on a customized optical fiber mount 508 configured to vertically position individual optical fibers of the optical fiber array in a non-flat pattern such that the core regions of the individual optical fibers can be aligned to respective edge coupler waveguides of a warped PIC (e.g., PIC 201). In some cases, the optical fibers at different lateral positions (e.g., along x-axis) and/or their core regions may be vertically aligned according to a measured warpage profile of the corresponding warped PIC to match the locations of the edge coupler waveguide facets of the warped PIC to which the customized optical fiber array structure 501 will be coupled. In some embodiments, the v-grooves of the customized optical fiber array structure 501 may have opening depths and opening widths tailored according to the measured warpage profile of the PIC. As shown in FIG. 5B by tailoring one or both the opening width and the opening depth (e.g., etch depth) of the individual v-grooves, the relative vertical positions of the optical fibers can be customized. For example, a wider v-groove opening may position the optical fiber at lower vertical position, and a narrower v-groove opening may position the optical fiber at a higher vertical position (e.g., with respect to a flat top or bottom surface of the customized optical fiber mount 508. In some examples, e.g., when the v-grooves are formed by wet etching, increasing the width of an opening may increase depth of the opening. In other words, in some cases, width and depth of a v-groove may change proportionally during a fabrication process. The dashed line in FIG. 5B is guide to the eye indicating variation of the depths of different v-grooves resulting from tailored opening width. In some examples, wherein a difference between widths of two openings formed on the customized optical fiber mount 508 can be larger than 2%, larger than 4%, larger than 6% or larger than 8%.

In some cases, aligning and stabilizing a plurality of optical fibers on the customized optical fiber mount 508 may allow a larger ratio of optical fibers to be efficiently coupled to respective waveguide facets of a warped PIC (e.g., with an optical coupling efficiency greater than a threshold value), compared to a ratio of efficiently coupled optical fibers of a plurality of optical fibers mounted on the optical fiber mount 506 having a flat vertical profile.

FIG. 5C is a schematic diagram showing a closeup side view of an optical fiber positioned within a v-groove depicting the width (w) of the v-groove opening, the depth of the v-groove (d), the vertical offset (h) of the optical fiber, the core region 114 of the optical fiber and the center 115 of the core region. As described above, the vertical offset (h) of the optical fiber 112 may be adjusted by adjusting the width (w).

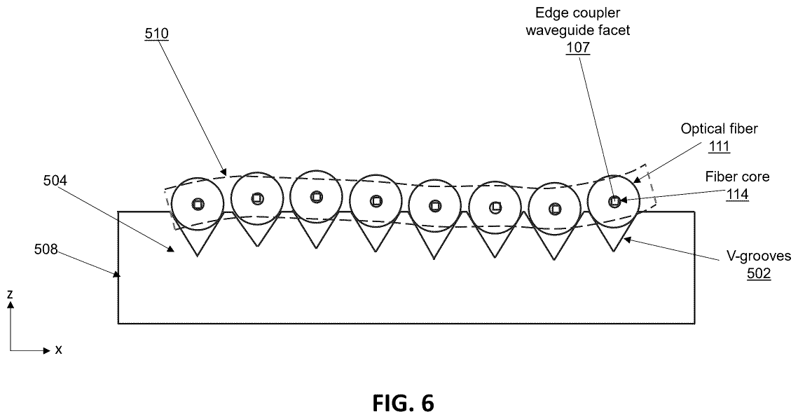

FIG. 6 is a schematic diagram illustrating a side view of a customized optical fiber array structure aligned with a warped PIC where individual v-grooves are tailored to align the core regions of the optical fibers to the respective edge coupler waveguide facets formed within the warped waveguide layer 510 of the warped PIC. The dashed line depicts the warped waveguide layer 510 of the PIC (other portions of the PIC not shown). In some embodiments, the opening width (w) and/or the opening depth (h) of individual v-grooves can be tailored to align a vertical offset (h) of the center of the optical fiber cores (e.g., with respect to the top surface of the fiber mount 508) such that fiber cores are at least vertically aligned with the respective edge coupler waveguide facets. In some cases, vertical alignment between core region 114 of an optical fiber 122 and an edge coupler waveguide facet 107 may comprise, a vertical distance between the top major surface of the fiber mount 508 and the center of the core region 114 and vertical distance between the top major surface of the fiber mount 508 and a center of the edge coupler waveguide facet 107, being substantially equal or having a difference less than 1%, less than 5%, less than 10%, less than 20%, less than 30%, less than 40%, or less than 50% of a thickness of the corresponding edge coupler waveguide.

### Optical Alignment Using a Bent Optical Fiber Array

As described above in some cases a PIC chip (e.g., a single PIC chip or a PIC chip of a two-chip PIC) can be curved, warped, or otherwise deformed. For example, once a PIC (e.g., the two-PIC die 118 or the two-chip PIC 116) is attached to a carrier chip (e.g., the EIC die 102), the PIC chip may be bowed and the corresponding edge coupler facets may not be arranged in a straight line. In these cases, optically aligning an array of optical fibers mounted on a flat fiber mount and having core regions (e.g., centroids of the core regions in a flat plane to the corresponding edge coupler facets of the bowed PIC chip can be challenging. In some cases, optically aligning the array of optical fibers and the edge coupler facets may comprise adjusting the position of the optical fiber array with respect to the PIC chip along one or more degrees of freedom. In some cases, the one or more degrees of freedom may comprise six degrees of freedom (e.g., translation along x, y, z axis and rotation around x, y, z axis).

For example, if the optical fiber mount or carrier is planar, there will be some residual error associated with the alignment of the fibers to the edge coupling facets of the warped or curved PIC chip. Some of the methods described below may allow efficient optical coupling to a curved or warped PIC of a PIC die or a two-chip PIC. In some cases, the PIC may comprise a two-chip PIC and/or may comprise two groups of edge couplers aligned along two different edges of the PIC (or two-chip PIC).

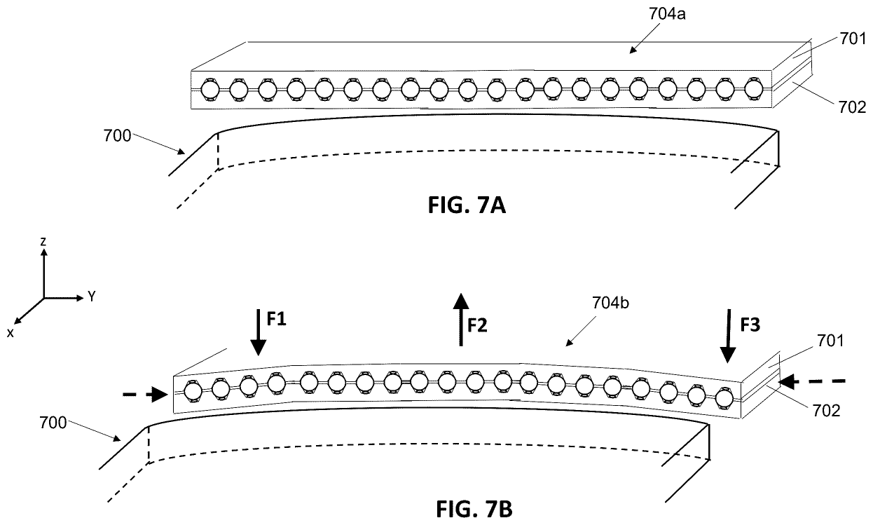

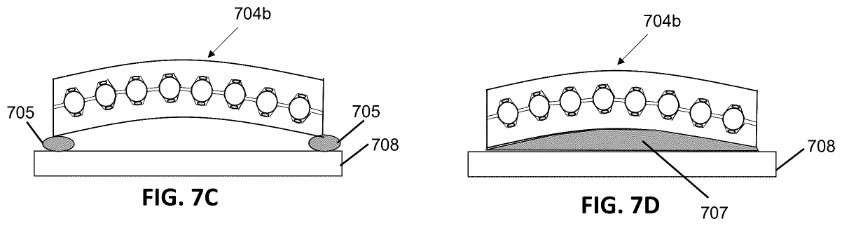

FIG. 7A is a schematic diagram showing a three-dimensional view of a flat optical fiber array 704a that is aligned with respect to a curved or warped PIC chip 700 to optically couple at least some of the optical fibers therein to respective edge coupler facets of the PIC chip 700. In some cases, the flat optical fiber array 704a may comprise a nominal unwrapped major surface.

In some cases, the optical fiber array 704a may comprise a plurality of optical fibers positioned and stabilized by an optical fiber mount. In some examples, the optical fiber mount may comprise one or two etched guide plates (e.g., silicon guide plates). In the example shown, the optical fiber array 704a is formed by capturing, positioning, and stabilizing a plurality of optical fibers using etched guide plates 701, 702, where an individual optical fiber is positioned with respect to the other optical fibers by a pair of grooves (e.g., v-grooves) each formed on one of the etched guide plates 701, 702. When the etched guide plates 701, 702 are flat the resulting optical fiber array can be flat, and the optical fibers, and in some cases their core regions, can be substantially within a flat surface (e.g., the centroids of their core region can be in the flat surface or a plane). As such, at least some of the optical fibers of the flat optical fiber array 704a may not be optically coupled or may be poorly coupled to the respective edge coupling facets of the bent, warped, or curved PIC 700 while some other optical fibers can be strongly to the respective edge coupling facets of the warped or curved PIC 700. It should be understood that a flat surface in this context may comprise a nominal unwrapped surface (e.g., nominal unwrapped surface major surface or an optical fiber mount or an etched guide plate). In some cases, at least two optical fibers of the flat optical fiber array 704a can be coupled to the respective edge coupling facets of the warped or curved PIC 700 with different optical coupling strengths. For example, first and second optical fibers may be coupled to the respective edge coupling facets with first and second optical coupling efficiencies or strengths, where the first optical coupling efficiency can be larger than the second optical coupling efficiency by a percentage that ranges from 3% to 5%, from 5% to 10%, from 10% to 15%, or a percentage in a range defined by any of these values, or larger values. In some cases, optically aligning the flat optical fiber array 704a and the warped or curved PIC 700 may comprise adjusting position of the flat optical fiber array 704a with respect to the warped or curved PIC 700, by moving one or both the flat optical fiber array 704a and the warped or curved PIC 700 along different rotational and/or translational directions to increase at least the first optical coupling. In some cases, the curvature or warpage of the PIC 700 may not allow simultaneous optimization of the first and second optical couplings, in some cases, independent of number of degrees of freedom available for such adjustment. In some cases, optical coupling between an optical fiber and an edge coupling facet may comprise optical coupling between a core region of the optical fiber and an optical waveguide (e.g., a bus optical waveguide) terminated by the edge coupling facet.

In some embodiments, an optical fiber of the flat optical fiber array 704a may comprise a single-mode fiber having a core region that supports a single mode. In some cases, the core region of the single mode fiber may be referred to as the single mode region.

In some embodiments, the optical fiber array 704a can be bent (e.g., mechanically bent) to optically align the core regions (e.g., centroid of the core regions) of the optical fibers to the respective edge coupler facets and thereby improve the optical coupling between individual optical fibers and the optical waveguide of the PIC. FIG. 7B is a schematic diagram showing a three-dimensional view of a mechanically bent optical fiber array 704b that is bent and aligned with respect to a curved or warped PIC chip 700 to optically couple all or majority of the optical fibers of the optical fiber array 704b to respective edge coupler facets of the warped or curved PIC chip 700. In some embodiments, during the alignment and optical coupling process forces (e.g., F1, F2, and F3) may be judiciously applied to different regions of the flat optical fiber array 704a to form the bent optical fiber array 704b. At least some of these forces may be applied on the optical fiber array by an end effector attached to a positioning robot having multiple degrees of freedom. For example, a tip portion of the end effector may be contacted with a fiber mount of the flat optical fiber array 704a at a first position on the fiber mount to apply a first force on the first position. Further, in some cases, a tip portion of a second end effector may be contacted with the fiber mount at a second position on the fiber mount to apply a second force on the second position.

In some examples, the positioning robot can have six degrees of freedom corresponding to three translational positions with respect to xyz axes, and three for rotational positions with respect to xyz axes. In some embodiments, the curvature of the bent or curved optical fiber array 704b may be dynamically controlled (e.g., during optical alignment) to match the curvature of the bent optical fiber array 704b to that of the curved PIC 700. In some embodiments, the curvature of the bent or curved optical fiber array 704b may be dynamically controlled (e.g., during optical alignment) to increase optical coupling between an optical fiber and a respective edge coupler facet without affecting or by minimally affecting optical coupling between another optical fiber of the optical fiber array and the respective edge coupler facet. In some embodiments, two optical fibers of the flat optical fiber array 704a that are coupled to the respective edge coupling facets of the warped or curved PIC 700 with different optical coupling strengths may become optically coupled to the respective edge coupling facets with substantially the same optical coupling strength when the flat optical fiber array 704a is transformed to the bent optical fiber array 704b in response to applying one or more forces (e.g., F1, F2, and F3). For example, a difference between first and second optical coupling strengths of the first and second optical fibers and the respective edge coupling facets may decrease by a percentage that ranges from 2% to 4%, from 8% to 12%, or a value in a range defined by any of these values, or larger values, when the flat optical fiber array 704a is transformed into the bent optical fiber array 704b. In some embodiments, the alignment arrangement between the flat optical fiber array 704a and the warped or curved PIC 700, may comprise a reference misalignment and the alignment arrangement between the bent optical fiber array 704b and the warped or curved PIC 700, may comprise a misalignment that is substantially smaller relative to a reference misalignment.

In some embodiments, during the alignment process optical powers coupled from individual optical fibers of the bent optical fiber array 704b to the individual waveguides of the curved PIC 700 or from the individual waveguides of the curved PIC 700 to the individual optical fibers of the bent optical fiber array 704b, may be monitored or measured (e.g., using one or more photodetectors, or a photodetector array). The optical power coupled from individual optical fibers of the bent optical fiber array 704b to the individual waveguides of the curved PIC 700 or from the individual waveguides of the curved PIC 700 to the individual optical fibers of the bent optical fiber array 704b may comprise optical power transmitted from an individual optical fiber to an individual waveguide or optical power transmitted from the individual waveguide to the individual optical fiber. In some such embodiments, the applied forces may be dynamically adjusted to maximize or improve one or more of the monitored optical powers. In some cases, the translational and rotational positions of the bent optical fiber array 704b with respect to the curved PIC 700 may be adjusted simultaneously or sequentially with the adjustment of the applied forces, to maximize or improve one or more of the monitored optical powers. For example, the translational and rotational positions of the flat optical fiber array 704a with respect to the curved PIC 700 may be adjusted to maximize or improve one or more of the monitored optical powers in the absence of any force on the flat optical fiber array 704a, then forces may be applied to one or more regions of the flat optical fiber array 704a to improve one or more of the monitored optical powers by forming the bent optical fiber array 704b, next the translational and rotational positions of the bent optical fiber array 704b with respect to the curved PIC 700 may be adjusted to further improve one or more of the monitored optical powers, and then the forces applied on one or more regions of the bent optical fiber array 704b may be adjusted to further improve one or more of the monitored optical powers. The entire or portion of this sequence may be repeated one or more times to maximize or improve one or more of the monitored optical powers and thereby the optical coupling between the individual optical fibers of the bent optical fiber array 704b and the individual waveguides (e.g., bus optical waveguides) of the curved PIC 700.

In some embodiments, prior to bending, a first optical coupling strength measured between a first waveguide facet of the curved PIC 700 and a first optical fiber of the flat optical fiber array 704a can be different from a second optical coupling strength (or efficiency) between a second waveguide facet of the curved PIC 700 and the second optical fiber by a percentage ranging from 3% to 5% from 5% to 10%, from 10% to 15%, or a percentage in a range defined by any of these values, or more. In some embodiments, applying forces on the flat optical fiber array 704a can increase one or both the first and second optical coupling strengths. In some embodiments, applying forces on the flat optical fiber array 704a may decrease the difference between first and second optical coupling strengths. In some cases, after bending, the difference between the first and second optical coupling strengths may decrease to 5% or less, to 3% or less, to 2%, or a value in a range defined by any of these values, or less.

In some embodiments, applying a force on an optical fiber array may comprise applying a first force on a first location on the corresponding fiber substrate (e.g., etched guide plate) and applying a second force on a second location on the fiber substrate (e.g. by contacting first and second robotic end effectors with the fiber substrate at the first and second positions). In some embodiments, the magnitude of the first and second forces may be determined based at least in part on the measured warpage or curvature of the PIC 700. In various examples, the warpage or curvature of the PIC 700 may be measured by imaging an edge of the PIC 700 (e.g., the edge comprising the coupler facets) and/or a profile of the a major surface of the PIC 700 (as described above with respect to FIG. 2A).

Once a desired level optical coupling between edge coupler facets, and thereby optical waveguides, of the curved PIC 700 and the respective optical fibers of the bent optical fiber array 704b is achieved, the position of the individual optical fibers relative to the respective individual optical waveguides may be locked to maintain the desired level of optical coupling between them when the forces are removed. In some embodiments, the position of the individual optical fibers relative to respective individual optical waveguides may be locked by locking the position of the bent optical fiber array 704b with respect to the bent or curved PIC 700. In some examples, once the bent optical fiber array 704b is locked in place, the forces may be removed.

In some embodiments, the bent optical fiber array 704b may be attached, glued, or otherwise secured to the bent PIC chip 700, or a common substrate (e.g., the EIC die 102) on which the bent PIC chip 700 is mounted, to maintain the curvature of the bent optical fiber array 704b after removal of the bending forces (F1, F2, and F3) and to maintain the relative position of individual optical fibers relative to the respective edge coupler facets.

FIGS. 7C-7B shows the bent optical fiber array 704b secured (e.g., glued) to a substrate 708 to maintain the curvature when the forces that originally generate the curvature are removed. As shown in FIG. 7C, in some embodiments, the bent optical fiber array 704b may be secured to the substrate 708 by applying an adhesive 705 between selected regions of the bent optical fiber array 704b and the substrate 708. In some embodiments, the bent optical fiber array 704b may be secured to the substrate 708 by applying an adhesive 707 layer between the bottom major surface of the bent optical fiber array 704b and the substrate 708. As shown in FIG. 7D, in some examples, the adhesive 707 layer may fill a major portion of a gap between the bottom major surface of the bent optical fiber array 704b and the substrate 708.

In some embodiments, the stabilized optical fiber arrays shown in FIGS. 7C and 7D may be coupled to the bent PIC 700 forming a PIC assembly. In some such cases, the bent and stabilized optical fiber array may be mounted on a common carrier. In some cases, the PIC assembly may comprise the bent PIC 700 and the bent optical fiber arrays mounted on the substrate 708 serving as a common substrate. In some cases, the PIC assembly may comprise a photonic switch assembly. The photonic switch assembly may comprise an optical switch network. The optical switch network may comprise a MEMS optical switch.

In some embodiments, the fiber facets of the flat optical fiber array 704a and the edge coupler facets of the warped or curved PIC 700 may have a reference alignment arrangement. In some such embodiments, the fiber facets of the bent optical fiber array 704b and the edge coupler facets of the warped or curved PIC 700 may have an alignment arrangement, different from the reference alignment arrangement, such that optical coupling coefficients between the edge coupler facets and the fiber facets are generally improved compared to optical coupling coefficients between the edge coupler facets of the warped or curved PIC 700 and the fiber facets of the flat optical fiber array 704b.

In some embodiments, reference alignment arrangement may comprise randomly distributed vertical displacements (e.g., along z-axis) of the core regions of the fiber facets (e.g., the centroids of the core regions or single mode zones) relative to a reference plane corresponding to a major surface of the flat optical fiber array 704a. In some embodiments, alignment arrangement may comprise the core regions of the fiber facets (e.g., the centroids of the core regions or single mode zones) having substantially the same vertical displacements (e.g., along z-axis) relative to the reference plane corresponding to a major surface of the flat optical fiber array 704a. In some embodiments, a maximum vertical distance in the distribution of vertical distances of the centroids of the core regions (e.g., single mode zones) from the reference plane can be smaller for alignment arrangement compared to reference alignment arrangement by a factor ranging from 1.5 to 2, from 2 to 2.5, from 2.5 to 3, or any values formed by these ranges or larger or smaller values.

In some embodiments, the alignment arrangement may comprise an alignment error that is lower relative to that of the reference alignment arrangement. In some embodiments, the alignment error may comprise a maximum vertical distance in the distribution of vertical distances of the centroids of the core regions (e.g., single mode zones) from the reference plane, a maximum value in a distribution of optical coupling efficiencies between optical fibers and the respective edge coupler facets, and/or a mismatch between curvature or warpage of the optical fiber array and curvature or warpage of the PIC. In some cases, the alignment arrangement may have an alignment error that is lower than an alignment error of the reference alignment arrangement by a factor ranging from 2 to 3, from 3 to 4, from 4 to 5, from 5 to 6, or any arrange formed by these values or larger or smaller values.

In some embodiments, the warped or curved PIC 700 with may have a first curvature signature and, after being secured, the bent optical fiber array 704b may have a second curvature signature. In some embodiments, the second curvature signature may generally track the first curvature signal. In some examples, the first curvature signature may comprise a peak-to-valley of a major surface of the warped or curved PIC 700 and the second curvature signature may comprise a peak-to-valley of a major surface of the bent/curved optical fiber array 704b. When a wafer curvature signature generally resembles a bowl (or inverted bowl), for example, the peak-to-valley can be defined by the depth of the valley at a central region of the wafer. In some examples, peak-to-valley of a major surface of the warped or curved PIC 700 can be from 1 to 5 microns, 5 to 10 microns, 10 to 15 microns, 15 to 20 microns, 30 to 50 microns or any ranges formed by these values or larger or smaller. In some examples, peak-to-valley range of a major surface of the bent/curved optical fiber array 704b can be from 1 to 5 microns, 5 to 10 microns, 10 to 15 microns, 15 to 20 microns, 30 to 50 microns or any ranges formed by these values or larger or smaller.

In some embodiments, the position and curvature of the bent optical fiber array 704b may be controlled by a robotic end effector with six degrees of freedom (e.g., three for controlling translational positions with respect to xyz axes, and three for controlling rotational positions with respect to xyz axes) and an end effector that can grip the fiber carrier or fiber mount (e.g., the fiber mount formed by the two etched guide plates 701, 702) in one, two, three or more locations. In some embodiments, the end effector can bend the fiber carrier (or fiber mount) to substantially match the curvature of the curved CIP 700. By using an adhesive, e.g., a UV or thermally curable adhesive, the fiber carrier can be locked in position in the deformed shape necessary for improved or optimized optical coupling.

In some embodiments, a feedback loop may be used to control the end effector based on measured optical powers coupled from the individual optical fibers to the individual waveguides (or vice versa). For example, the feedback loop may provide positive feedback to the end effector when a measured coupled optical power is improved and negative feedback when a measured coupled optical power is degraded. In some embodiments, optical power maty be provided to individual optical fibers or optical waveguides and the optical powers coupled from the individual optical fibers to the individual waveguides (or vice versa) may be measured before, during, and after transformation of the flat optical fiber array 704a to the bent optical fiber array 704b. In some embodiments, embodiments, the alignment and bending process may comprise an automatic or semi-automatic process where at least a portion of the alignment, e.g., application a force and/or adjusting a position, is performed by a controller based at least in part on a measured optical power transmitted between an optical fiber of the bent optical fiber array 704b and an optical waveguide of the curved of bent PIC 700. In some cases, the controller may comprise a field programable gate array (FPGA). In some cases, the controller may comprise a non-transitory memory storing machine executable instructions and an electronic processor configured to execute the machine executable instructions to perform at least a portion of the alignment process. In various embodiments, forces (e.g., F1, F2, and F3) may be applied at three or more locations on the optical fiber array or the corresponding optical fiber mount to achieve bending of the fiber carrier to substantially match the curvature of the curved PIC chip 700. Force can be applied by gripping mechanically, by vacuum or other means. Force can also be applied horizontally (e.g., along y-axis) to bend or flex the fiber carrier along a vertical direction (e.g., +Z or −z along the z-axis). In some cases, at least one of the forces may be applied on the optical fiber mount as a result of applying two other forces. For example, with reference to FIG. 7B, a middle region of the bent optical fiber array 704b may be immobilized by a fixed supporting structure (e.g., underneath the bent optical fiber array 704b) such that when F1 and F2 are applied downward (e.g., opposite to z-direction) near the two lateral ends of the optical fiber array 704b, the fixed support applies a an upward force F2 in the middle region of the bent optical fiber array 704b.

In various embodiments, the curved PIC chip 700 may comprise a two-chip PIC (e.g., the two-chip PICs 116, 118) or any other PIC. In some cases, the curved PIC chip 700 may comprise two groups of edge coupler facets arranged along two different edges (e.g., similar to the two-chip PIC shown in FIG. 1E). In some such cases, a first optical fiber array may be aligned, bent, and secured to provide optical coupling to a first group edge coupler facets, and subsequently a second optical fiber array may be aligned, bent, and secured to provide optical coupling to a second group edge coupler facets. In various implementations, the first and second optical fiber arrays may be aligned, bent, and secured simultaneously or sequentially.

### Rotational Adjustment of an Optical Fiber Array

In some embodiments, the core regions (e.g., the centroid of the core regions) of optical fibers mounted on an optical fiber mount 809 or carrier can have different vertical displacements (e.g., along z-axis) with respect to a plane parallel to a flat major surface of the optical fiber mount 809 and/or different lateral displacements (e.g., along x-axis) with respect to predetermined positions associated with the individual grooves (e.g., v-grooves) of the optical fiber carrier or mount 809. In some cases, different vertical and lateral displacements of the core regions may be characterized by a radial displacement or position of the centroids of the core regions of different optical fibers of the array with respect to centroids of the respective optical fibers (e.g., centers of the circular cross-sections of the respective optical fibers, also referred to as geometrical centroid of the corresponding fiber facet), in combination with an angular displacement or position of the centroids of the core regions with respect to a reference plane or axis, e.g., a horizontal plane (x-y plane) or axis (x axis) corresponding to a major surface of the optical fiber mount 809. In some embodiments the optical fiber mount 809 may comprise first and second etched guide plates 701, 702 configured to arrange the optical fibers respect to one another.

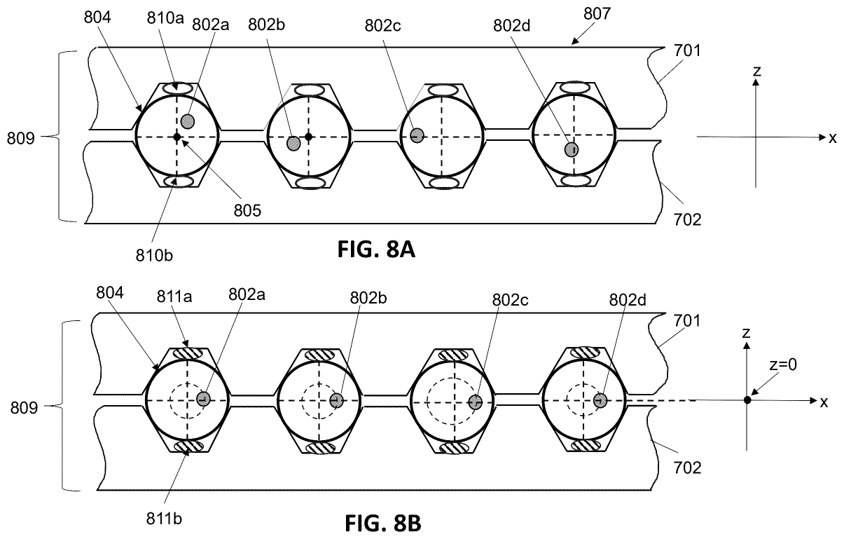

FIG. 8A is a schematic diagram showing a side view of a portion of an optical fiber array where core regions of individual optical fibers 802a-802d are randomly positioned with respect to specified or reference positions associated with respective grooves or optical fibers. In some cases, the random positions of individual core regions may be disposed at distances from the specified or reference positions along a vertical direction substantially perpendicular to a major surface of the first etched guide plate 701 and/or the second etched guide plate 702 (e.g., z-axis in FIG. 8A), and at distances from the specified or reference positions along a lateral direction perpendicular to the vertical direction and parallel to a vertical facet of the first etched guide plate 701 and/or guide plate 702 (e.g., x-axis in Figured 8A).

In some embodiments, the specified positions may correspond to geometric centers centroids of the respective optical fibers. For example, the specified position 805 for the first optical fiber 804 of the optical fiber array shown in FIG. 8A can be the geometric center of the circular cross-section of the first optical fiber 804. In some embodiments, the specified positions may comprise positions within a plane parallel to a major surface of the first etched guide plate 701 or the second guide plate 702. In some embodiments, the specified positions may correspond to centers (e.g., geometric centers or centroids) of grooves (e.g., v-grooves) that capture and stabilize the optical fibers. In some embodiments, the specified positions may correspond to geometric centers or centroids of the edge coupler facets of the PIC chip to which the optical fiber is coupled.

As shown in FIG. 8A, the position of the core region (e.g., the single mode zone) within an individual optical fiber may not be at a predetermined position with respect to a specified position for the corresponding fiber. For example, the core regions of the optical fibers of the optical fiber array shown in FIG. 8A are located at random vertical and horizontal positions with respect to specified or reference positions. Such random arrangement of the fiber cores can increase the error in alignment to the fixed input waveguides (e.g., edge coupler facets of the input waveguide) of the PIC chip, resulting in excessive optical insertion loss. The method disclosed herein may be used to adjust the orientation of individual fibers within the optical fiber mount 809 (also referred to as capture structure) to reduce relative misalignment between core regions 802a-802d with respect to a specified position and thereby facilitate the optical alignment and coupling of the optical fiber array to the PIC chip. In some cases, the specified position (z=0 in this example) comprises a vertical position along a direction (e.g., along z-axis) perpendicular to a major surface of the fiber mount 809 (e.g., the top surface 807 of the first etched guide plate 701). In some embodiments, after placing the optical fibers in the capture structure formed by the etched guide plates 701, 702, and before securing the optical fibers to the optical fiber mount 809, the optical fibers 802a-802d may be individually rotated (e.g., along their cylindrical axis of symmetry or y-axis in the example shown) to bring the respective core regions closer to a center plane substantially parallel to a major flat surface of one or both etched guide plates 701, 702 (e.g., a plane passing through z=0 in the example shown). In some examples, the centroids of the core regions 802a-802d may be rotated to be substantially positioned within a center plane parallel to a major flat surface of one or both etched guide plates 701, 702. In other words, the centroids of the core regions 802a-802d may be rotationally adjusted such that relative displacements of all core regions 802a-802d can be substantially zero or near zero along a vertical direction perpendicular to a major flat surface of one or both etched guide plates 701, 702.

The rotational adjustment may comprise rotating individual optical fibers in the same or different directions. Once the rotational adjustment is complete, individual optical fibers may be secured in place, e.g., by being glued to the optical mount 809 (e.g. to one or both first and second etched guide plates 701, 702) using UV curable glue or thermally curable glue.

FIG. 8B is a schematic diagram showing a side view of an optical fiber array where the angular positions of the core regions 802a-802d of individual optical fibers are adjusted about the x-axis to position the core regions 802a-802d in a single plane parallel to a major surface (e.g., the top surface 807) of the optical fiber mount 809. In some cases, adhesive beads may be provided between the individual fibers and the etched guide plates 701, 702 (e.g., two beads of UV or thermally curable adhesive 810a, 810b between the first optical fiber 804 and the etched guide plates 701, 702). The individual fibers may be rotated such that the respective core regions 802a, 802b, 802c, and 802d, are substantially aligned along a common vertical position with respect to the to surface 807 (e.g., at z=0), and the adhesive beads may be cured to mechanically stabilize the optical fibers. For example, when the adhesive beads are formed of UV-curable material, illuminating the adhesive beads 810a, 810b with UV light can form cured adhesive beads 811a, 811b, thereby securing the first optical fiber 804 to the etched guide plates 701, 702. Advantageously, reducing or eliminating the relative misalignment (e.g., relative vertical misalignment) of core regions with respect to at least one axis (e.g., z-axis) may allow efficient optical coupling of all or majority of optical fibers of the optical fiber array to respective edge coupler facets of a PIC chip. Additionally, reducing or eliminating the relative misalignment of core regions with respect to at least one axis, can facilitate optical alignment of individual optical fibers of the optical fiber array to the respective edge coupler facets by eliminating the need to actively adjust the alignment with respect to that axis, and limiting the active alignment to the alignment with respect to the second axis (e.g., x-axis in the example shown). In some embodiments, rotational adjustment of individual optical fibers of an optical fiber array prior to securing the optical fibers to an optical fiber mount can reduce an alignment error to a single axis alignment problem, and the error in that axis may be reduced by a factor ranging from 1.2 to 1.5, from 1.5 to 2, from 2 to 2.5, from 2.5 to 3, from 3 to 4 or a value in a range defined by any of these values, or larger values. In some cases, the alignment error may comprise a distance or displacement between a core region of an optical fiber and a corresponding edge coupler facet, within a plane perpendicular to a major surface of the optical fiber mount.

In some embodiments, the optical waveguides of the PIC and thereby the corresponding edge coupler facets may comprise a rectangular shape elongated along the lateral direction (e.g., x-axis). In some cases, the widths along the lateral direction (e.g., x-axis) of an optical waveguide of the PIC an the corresponding edge coupler facet can be greater than its height along the vertical direction (e.g., z-axis) by a factor ranging from 1.2 to 1.5, from 1.5 to 2, from 2 to 3, from 3 to 5 or any ranges formed by these values or larger or smaller values. As such, in some such embodiments, the optical coupling between the edge coupler facet and an optical fiber can be more sensitive to vertical misalignment compared to lateral alignment, between the centroid of the core region of the optical fiber and a center of the edge coupler facet. Thus, in some cases, eliminating or reducing the relative misalignment of core regions (e.g., centroids of the core regions) along the vertical axis, may significantly improve the optical couplings efficiencies between the edge coupler facets and the fiber facets, in the presence of lateral misalignments between the centroid of the core region of the optical fiber and a center of the edge coupler facet (as shown in FIG. 8B). In some cases, eliminating or reducing the vertical misalignment of core regions (e.g., centroids of the core regions) along the vertical axis, may facilitate the alignment between the PIC and the fiber array by reducing a two-dimensional alignment process to a one-dimensional alignment process.

In some embodiments, the fiber facets of the optical fiber array shown in FIG. 8A and the edge coupler facets of a PIC may have a reference alignment arrangement. In some such embodiments, the fiber facets of the optical fiber array shown in FIG. 8B and the edge coupler facets of the PIC may have an alignment arrangement, different from the reference alignment arrangement, such that optical coupling coefficients between the edge coupler facets and the fiber facets are generally improved compared to optical coupling coefficients between the edge coupler facets of the PIC and the fiber facets of the flat optical fiber array shown in FIG. 8A.

In some embodiments, reference alignment arrangement may comprise randomly distributed angular displacements of the centroids of the single mode zones relative to the plane corresponding to the major surface of the fiber mount 809. In some embodiments, alignment arrangement may comprise the centroids of the single mode zones having substantially the same angular displacements relative to the plane corresponding to the major surface of the fiber mount 809.

In some embodiments, the alignment arrangement may comprise an alignment error that is lower relative to that of the reference alignment arrangement. In some embodiments, the alignment error may comprise a maximum angular displacement in the distribution of angular displacements of the centroids of the core regions (e.g., single mode zones) from the reference plane and/or a maximum value in a distribution of optical coupling efficiencies between optical fibers and the respective edge coupler facets of the PIC. In some cases, the alignment arrangement may have an alignment error that is lower by at least a factor of two, a factor of four, a factor of 6, or larger values compared to the reference alignment arrangement.

In some embodiments, adjusting the rotational positions of the core regions 802a-802d may comprise imaging the corresponding optical fiber facets to determine the random positions of the core regions 802a-802d (as shown in FIG. 8A), and rotating individual optical fibers within the respective grooves of the optical mount 809. In some embodiments, the facets of the individual optical fibers may be imaged using an imaging system comprising an image sensor and imaging optics configured to form an image of the facets on the image sensor. In some cases, an electronic system may receive signals (e.g., digital signals) from the image sensor and determine the position of the core regions 802a-802d by processing the signals. In some cases, light having wavelengths within a response bandwidth of the image sensor may be provided to individual optical fibers to facilitate determining the position of the core regions 802a-802d.

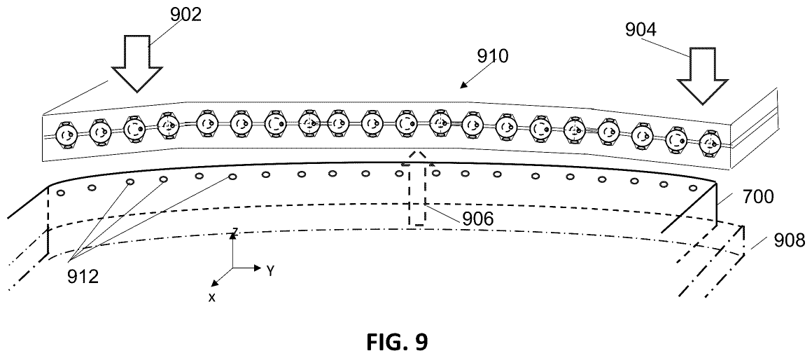

In some embodiments, the optical alignment method described above with respect to FIG. 7B may be used to optically couple an optical fiber array whose optical fibers are rotationally adjusted using the method described with respect to FIG. 8B, to the curved or warped PIC 700 (FIG. 7B). In some cases, the curved or warped PIC 700 may be bonded to a substrate (e.g. a carrier substrate or an EIC die, e.g., as shown in FIGS. 1A-1B). In some such cases, the curvature or warpage of the PIC 700 may have originated by the bonding the PIC 700 to the substrate. FIG. 9 is a schematic diagram showing a three-dimensional view of a mechanically bent optical fiber array 910 optically aligned with the curved or warped PIC 700 to optically couple individual optical fibers of the bent optical fiber array 910 to respective edge coupler facets 912 of the curved or warped PIC 700. In some cases, prior to mechanical bending, optical fibers of a flat optical fiber array are rotationally adjusted within the respective grooves of the corresponding etched guide plates 701, 702, and then mechanically secured to the flat optical fiber mount. Next, forces are applied to mechanically transform the flat optical fiber array to the bent optical fiber array 910 and the bent optical fiber array 910 is optically aligned with the bent or curved PIC 700. In some cases, the core regions of the optical fibers within the bent optical fiber array 910 can be positioned in a single curved surface having substantially the same curvature of the optical fiber mount (or capture structure). In some cases, bending the optical fiber mount may comprise applying forces on the fiber mount (e.g., vertically, e.g., along z-axis, on one or more major surfaces and/or laterally, e.g., along y-axis, on one or more side surfaces). In some cases, the forces may be applied using mechanically or electromechanically controlled probe tips 902, 904, 906 (e.g., robotic end effectors) on the top and bottom major surfaces of the optical fiber mount. In some embodiments, the forces are applied to provide the bent optical fiber array 910 first, followed by aligning the bent optical fiber array 910 with the PIC 700. In some other embodiments, the flat optical fiber array is pre-aligned with the PIC 700 first, followed by applying the forces to provide the bent optical fiber array 910, and the bent optical fiber array 910 is further aligned with respect to the PIC 700 to optimize optical coupling therebetween. In some embodiments, the bending and alignment processes may be performed simultaneously, sequentially, or alternatingly, to provide optimal optical coupling between individual optical fibers of the bent optical fiber array 910 and respective edge coupler facets 912 of the curved or warped PIC 700. In some cases, the curvature or warpage of the PIC 700 can be measured, e.g., by measuring a surface profile of the PIC 700 (e.g., the profile the top major surface) using an optical or stylus-based profilometer (as described above with respect to FIG. 2A) and/or by imaging the edge coupler facets using an imaging system. The flat optical fiber array may be mechanically bent to provide a pre-bent optical fiber array having an initial curvature or warpage substantially matched to the measured curvature or warpage of the PIC 700. The pre-bent optical fiber array may subsequently be optically aligned to the PIC 700. In some cases, one or both the curvature and/or warpage of the pre-bent optical fiber array and the optical alignment may be further adjusted to further improve optical coupling and provide the bent optical fiber array 704 that is optimally coupled to bent or curved the PIC 700. As such, in various embodiments, a flat optical fiber array may be mechanically bent to substantially match a curvature of the resulting bent optical fiber array to that of a corresponding curved PIC and/or to improve optical couplings between optical fibers of the bent optical fiber array and the respective edge coupler facets.

In some embodiments, with reference to FIGS. 7A-7B, the transformation of the flat optical fiber array 704a to the bent optical fiber array 700 may be achieved by integrating a thermal bending layer or a thermal bending layer stack with the optical fiber optical array such that a curvature of the resulting structure and thereby the optical fiber array can be controlled or adjusted by changing the temperature of the structure. In some other embodiments, the transformation of the flat optical fiber array 704a to the bent optical fiber array 700 may be achieved by attaching a thermal bending layer to the flat optical fiber array 704a using a thermally cured adhesive. In various implementations, the thermal bending layer or stack may be attached, disposed, or integrated on a major surface of an etched guiding plate of the optical fiber array.

In some embodiments, the thermal bending layer may comprise a layer having a coefficient of thermal expansion different from thar an etched guiding plate of the optical fiber array. In some cases, the difference between the coefficient of thermal expansion thermal bending and the etched guide plate can be from 0.5 to 2 ppm/° C., from 2 to 5 ppm/° C., from 5 to 10 ppm/° C., from 10 to 15 ppm/° C., from 15 to 20 ppm/° C., from 20 to 25 ppm/° C., or any ranges formed by these values or larger or smaller values. In some embodiments, the thermal bending stack may comprise multiple vertically stacked layers configured to bend in response to a temperature change. In some examples, the thermal bending stack may comprise a thermal layer bilayer comprising two layers having different coefficients of thermal expansion (CTE). In some cases, the difference between the coefficient of thermal expansions of two layers of the thermal bending stack can be from 0.5 to 2 ppm/° C., from 2 to 5 ppm/° C., from 5 to 10 ppm/° C., from 10 to 15 ppm/° C., from 15 to 20 ppm/° C., from 20 to 25 ppm/° C., or any ranges formed by these values or larger or smaller values. In some cases, the bilayer may comprise a silicon/metal bilayer, a silicon dioxide/metal bilayer, a silica/silicon bilayer, or the lake. In some examples, metal may comprise aluminum, copper, nickel, steel or the like.

In some cases, the thermal bending layer may comprise a layer or a layer stack having a coefficient of thermal expansion (CTE) different from that of the one or both of etched guide plates that capture the optical fibers to optical fiber array, or different from that of the corresponding optical fiber mount. In some cases, the thermal bending layer stack may be a bilayer formed of two layers (e.g., two metallic layers) having different CTEs. The different CTEs force the bilayer to bend one way if heated, and in the opposite direction if cooled below its initial temperature. In some embodiments, the thermal bending layer or thermal bending layer stack may extend in a plane parallel to a major surface (e.g., bottom major surface) of the optical fiber mount or an etched guide plate of the optical fiber array (e.g., parallel to x-y plane). In some embodiments, the thermal bending layer or thermal bending layer stack may be formed of a suitable material or materials having a thickness or thicknesses such that in response to a temperature change, sufficient stress is exerted to bend the optical fiber array. The thermal bending layer or the thermal bending layer stack may comprise one or more metals.

In some cases, the thickness of the thermal bending layer can be from 1 to 5 μm, from 5 to 10 μm, from 10 to 15 μm, from 15 to 20 μm, or any ranges formed by these values or larger or smaller. In some cases, the thickness of the thermal bending stack can be from 1 to 10 μm, from 10 to 20 μm, from 20 to 30 μm, from 30 to 40 μm, or any ranges formed by these values or larger or smaller.

In some embodiments, the thermal bending layer or thermal bending layer stack may comprise a semiconductor (e.g., silicon), a dielectric (e.g., silicon dioxide), a metal (e.g., aluminum, copper, nickel), or polymer (e.g., polyimide). However, embodiments are not so limited and the thermal bending layer or thermal bending layer stack may comprise other materials.

In some embodiments, the thermal bending bilayer or stack may be formed (e.g., deposited) on a top or bottom major surface of the flat optical fiber array 704a to provide a thermally sensitive optical fiber array. In various implementations, the thermal bending bilayer or stack may be formed on a major surface of an etched guide plate of the flat optical fiber array 704a before or after mounting the optical fibers and forming the optical fiber array (e.g., by connecting the top and bottom etched guide plates). The thermally sensitive optical fiber may be aligned and optically coupled to the bent or curved PIC 700 using the methods described above with respect to FIGS. 7A-7B, and 9. However, instead of mechanically bending the optical fiber array by applying external forces (F1, F2, F3) using end effectors and probe tips, in this case the warpage and/or curvature of thermally sensitive optical fiber array may be adjusted by changing the temperature of the optical fiber array to substantially match the warpage and/or curvature of the CIP 700 and/or to improve optical coupling between the optical fibers of the optical fiber array and the edge coupling facets of the PIC. Once a desired curvature, warpage profile, and/or optical coupling efficiency and distribution over all optical fibers is achieved, the bent optical fiber array may be secured to a substrate (e.g., a substrate to which the PIC is bonded) using a curable adhesive (e.g., UV or thermally curable epoxy) as described above with respect to FIGS. 7A-7B, and 9.

In some embodiments, the thermal bending layer may be fabricated separately, a layer of temperature curing adhesive (e.g., epoxy) may be sandwiched between the flat optical fiber array 704a and the thermal bending layer, and the temperature of the resulting structure may be elevated for set period to cure the temperature curing adhesive such that once the adhesive (e.g., epoxy) is cured the resulting composite layered structure may have a desired curvature and warpage (e.g., substantially matched to those of the bent or curved PIC 700). In such embodiments, the curvature and/or warpage of the composite layered structure may be determined by one or both thickness of thermal bending layer and the curing temperature of the adhesive and thereby the composition and type of the thermally curing adhesive used.

With continued reference to FIGS. 7A-7B, in some embodiments, in addition or as an alternative to bending the flat optical fiber array 704a, the curvature of the bent or curved PIC 700 may be adjusted to correct the unintended warpage and/or curvature of the PIC 700, substantially match the warpage and curvature of the bent optical fiber array 704b and the PIC 700. In various implementations, the warpage and/or curvature of the PIC 700 may be controlled using the methods described above, including but not limited to, applying an external force (e.g., using a robotically controlled tip), forming a thermal tuning layer (e.g., a bilayer or a layer stack) on a major surface of the PIC 700 and adjusting the temperature of the resulting structure, or attaching a thermal tuning layer to the PIC using a thermally curing adhesive (e.g., epoxy). Once the curvature and/or warpage profile of the PIC 700 is adjusted, the PIC 700 may be secured to a substrate using a curable adhesive (e.g., UV or thermally curable adhesive) to stabilize the PIC and maintain its curvature and/or warpage profile.

In some cases, one of the above-mentioned controlled bending methods may be used to transform the curved or warped PIC 700 to a flat PIC hereby eliminating the need for bending the flat optical fiber array 704a. In some cases, same or different ones of the above-mentioned controlled bending methods may be used to control the curvature and/or warpage of both PIC and optical fiber array to substantially match their curvature or warpage and/or provide a desired optical coupling efficiency and distribution over all optical fibers.

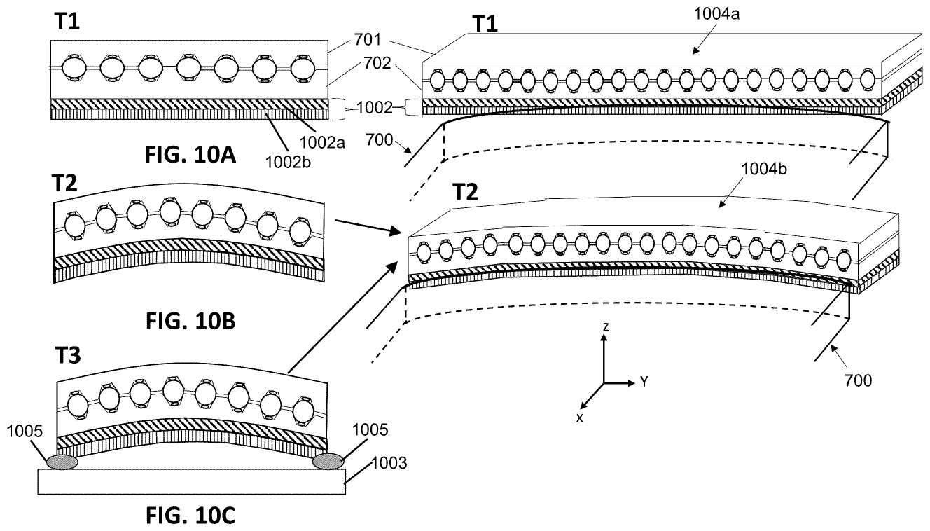

FIG. 10A-10C schematically illustrates the fabrication process of a bent optical fiber array comprising a thermal bending bilayer 1002. FIG. 10A shows a cross-sectional view of the flat optical fiber array 1004a comprising a first etched guide plate 701, a second etched guide plate 702, and a thermal bending bilayer 1002 formed (e.g., deposited) on bottom surface of the second etched guide plate 702 at temperature T1 (e.g., room temperature). FIG. 10B shows the bent optical fiber array 1004b formed in response to changing the temperature from T1 to T2. In some cases, the T2 can be greater than T1. FIG. 10C shows the bent optical fiber array 1004b secured (e.g., glued) to a substrate 1003 after the temperature is changed to T3. In some embodiments, the bent optical fiber array 1004b may be secured to the substrate 1003 by applying an adhesive 1005 between selected regions of the bent optical fiber array 1004b and the substrate 1003. In some cases, T3 can be an operational or deployment temperature of the bent optical fiber array 1004b. In some cases, T3 can be substantially equal to T1. In some cases, T3 can be greater than T1 and the T2 can be greater than T1 and T3. The three-dimensional views of the flat optical fiber array 1004a and the bent optical fiber array 1004b, aligned with a bent PIC 700 are shown on the right sides of 10A and 10B, respectively. In some embodiments, instead of the thermal bending bilayer 1002, a single thermal bending layer or a thermal bending layer stack comprising more than two layers may be integrated with the flat optical array to provide the bent the bent optical fiber array 1004b in response to temperature change.

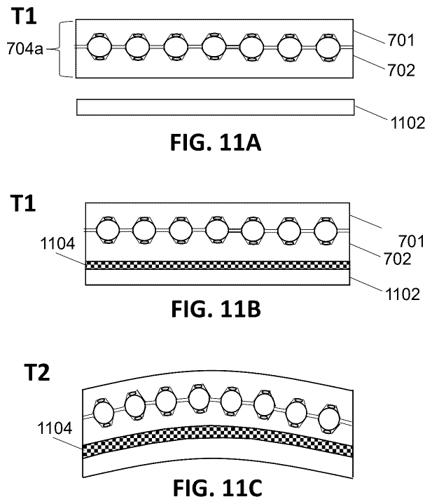

FIG. 11A-11C schematically illustrates the fabrication process of a bent optical fiber array using a thermal bending layer showing cross-sectional views of the optical fiber array, thermal bending layer, and the resulting bent composite structure. FIG. 11A shows cross-sectional views of the flat optical fiber array 704a and a thermal bending layer 1102 at temperature T1 (e.g., room temperature. In some cases, flat optical fiber array 704a and the thermal bending layer 1102 may be fabricated separately and then aligned to attach the thermal bending layer 1102 to a major surface of one of the first and second etched guide plates 701, 702, of the flat optical fiber array 704a. FIG. 11B shows application of an adhesive layer 1104 between bottom surface of the second etched guide plate 702 and the thermal bending layer 1102 (the resulting bent composite structure. FIG. 11C shows the thermal bending of the composite structure formed by the first and second etched guide plates 701, 702, and the thermal bending layer 1102, in response to changing the temperature from T1 to T2 to cure the adhesive layer 1104 and as a result bending the composite structure. In some cases, T3 can be an operational or deployment temperature of the bent optical fiber array. In some cases, T3 can be substantially equal to T1. In some cases, T3 can be greater than T1 and the T2 can be greater than T1 and T3.

### ADDITIONAL EXAMPLE EMBODIMENTS

Various additional example embodiments of the disclosure can be described by the following examples:

### Example Embodiments 1

Example 1. A photonic switch assembly, comprising:
a photonic integrated circuit (PIC) comprising an array of optical waveguides formed on a PIC substrate, the optical waveguides terminating with waveguide facets at a side surface of the PIC; and
an array of optical fibers disposed on a fiber substrate, the optical fibers terminating with fiber facets optically aligned with the waveguide facets,
wherein the fiber facets and the waveguide facets have an alignment arrangement comprising:
   the optical fibers having differently positioned single mode zones such that centroids of the single mode zones have different radial distances from geometric centroids of the fiber facets, and
   the centroids of the single mode zones having substantially the same angular displacements relative to a plane corresponding to a major surface of the fiber substrate.

Example 2. The photonic switch assembly of Example 1, wherein the alignment arrangement has an alignment error that is lower by at least a factor of two relative to that of a reference alignment arrangement that is the same as the alignment arrangement, except that the centroids of the single mode zones of the reference alignment arrangement have randomly distributed angular displacements relative to the plane corresponding to the major surface of the fiber substrate.

Example 3. The photonic switch assembly of Example 1, wherein the fiber substrate comprises a first etched guide plate having a first plurality of grooves formed thereon, and wherein the optical fibers are disposed in the first plurality of grooves.

Example 4. The photonic switch assembly of Example 3, further comprising a second guide plate having a second plurality of grooves formed thereon, and wherein the optical fibers are disposed vertically between the first and second pluralities of grooves.

Example 5. The photonic switch assembly of Example 3, wherein the optical fibers are fixed by a glue layer.

Example 6. The photonic switch assembly of Example 1, wherein the PIC substrate has a first curvature signature, and the fiber substrate has a second curvature signature, and wherein the second curvature signature generally tracks the first curvature signature.

Example 7. The photonic switch assembly of Example 6, wherein the alignment arrangement has an alignment error that is lower by at least a factor of two relative to that of a reference alignment arrangement that is the same as the alignment arrangement, except that the fiber substrate does not have the second curvature signature.

Example 8. The photonic switch assembly of Example 6, wherein the fiber substrate comprises a thermal bending stack comprising at least two layers having different coefficients of thermal expansion.

Example 9. The photonic switch assembly of Example 1, wherein the PIC is stacked over a complementary metal-oxide-silicon (CMOS) substrate comprising control circuitry to control optical switching of the PIC.

Example 10. The photonic switch assembly of Example 1, wherein the PIC comprises a first PIC die and a second PIC die stacked on the first PIC die.

Example 11. The photonic switch assembly of Example 1, wherein the PIC comprises a microelectromechanical systems (MEMS) optical switch.

Example 12. A method of fabricating a photonic switch assembly, the method comprising:
providing an optical fiber mount comprising a first optical fiber placed within a first groove of optical fiber mount, the first optical fiber having a first single mode zone;
placing a second optical fiber within a second groove of the optical fiber mount to form an optical fiber array, the second optical fiber having a second single mode zone;
rotating the second optical fiber within the second groove to reduce a vertical offset of a second centroid of the second single mode zone with respect to a first centroid of the first single mode zone; and
securing the second optical fiber to the optical fiber mount to prevent further rotation of the second optical fiber with respect to the optical fiber mount.

Example 13. The method of example 12, wherein securing the second optical fiber to the optical fiber mount comprises curing a UV curable glue provided between the second groove and the second optical fiber.

Example 14. The method of example 12, further comprising securing the first optical fiber to the optical fiber mount to prevent further rotation of the first optical fiber with respect to the optical fiber mount.

Example 15. The method of example 14, further comprising optically aligning the optical fiber array with respect to a photonic integrated circuit (PIC) to optically couple the first and second optical fibers to first and second waveguide facets of the PIC, wherein a difference between a first optical coupling strength between the first waveguide facet and the first waveguide facet and a second optical coupling strength between the second waveguide facet and the second waveguide facet, is less than 5%.

Example 16. The method of Example 15, wherein the PIC comprises a microelectromechanical systems (MEMS) optical switch.

Example 17. The method of example 12, further comprising:
placing a third optical fiber having a third single mode zone, having a third centroid, within a third groove;
rotating the third optical fiber within the third groove to reduce a vertical offset of a third centroid with respect to the second centroid; and
securing the third optical fiber to the optical fiber mount to prevent further rotation of the third optical fiber with respect to the optical fiber mount.

Example 18. The method of example 15, wherein the PIC comprises a bent PIC substrate and optically aligning the optical fiber array with respect to the PIC comprises:
translating one or both the optical fiber array and the PIC to optically align the first and second single mode zones with the first and second waveguide facets;
bending the optical fiber array to form a curved optical fiber array having a curvature matched to that of the bent PIC substrate; and
securing the bent optical fiber array to a substrate, after bending the optical fiber array, to maintain the curvature of the optical fiber array.

Example 19. The method of Example 18, wherein bending the optical fiber array comprises applying a force on the optical fiber mount and securing the bent optical fiber array comprises removing the force.

Example 20. The method of Example 18, wherein bending the optical fiber mount comprises changing the temperature of the optical fiber mount.

### Example Embodiments 2

Example 1. A photonic switch assembly, comprising:
a photonic integrated circuit (PIC) comprising an array of optical waveguides formed on a PIC substrate, the optical waveguides terminating with waveguide facets at a side surface of the PIC, wherein the PIC substrate has a first curvature signature; and
an array of optical fibers disposed on a fiber substrate, the optical fibers terminating with fiber facets optically aligned with the waveguide facets,
wherein the fiber facets and the waveguide facets have an alignment arrangement comprising:
   the fiber substrate having a second curvature signature,
   wherein the second curvature signature generally tracks the first curvature signature, and
   wherein the alignment arrangement has an alignment error that is lower relative to that of a reference alignment arrangement that is the same as the alignment arrangement, except that the fiber substrate does not have the second curvature signature.

Example 2. The photonic switch assembly of Example 1, wherein the second curvature signature is such that a major surface of the fiber substrate has a peak-to-valley range of 5-50 microns.

Example 3. The photonic switch assembly of Example 2, wherein the second curvature signature is permanently fixed by fixing the fiber substrate bent into shape on a cured substrate.

Example 4. The photonic switch assembly of Example 2, wherein the second curvature signature is permanently fixed by fixing the fiber substrate bent into shape on one or more thermal bending metallic layers.

Example 5. The photonic switch assembly of Example 1, wherein the first curvature signature is such that a major surface of the PIC substrate has a peak-to-valley range of 5-50 microns.

Example 6. The photonic switch assembly of Example 1, the alignment arrangement further comprises:
the optical fibers having differently positioned single mode zones such that centroids of the single mode zones have different radial distances from geometric centroids of the fiber facets, and
the centroids of the single mode zones having substantially the same angular displacements relative to a plane corresponding to a major surface of the fiber substrate.

Example 7. The photonic switch assembly of Example 5, wherein the alignment arrangement has an alignment error that is lower by at least a factor of two relative to that of a reference alignment arrangement that is the same as the alignment arrangement, except that the centroids of the single mode zones of the reference alignment arrangement have randomly distributed angular displacements relative to the plane corresponding to the major surface of the fiber substrate

Example 8. The photonic switch assembly of Example 1, wherein the fiber substrate comprises a first etched guide plate having a plurality of first grooves formed thereon, and wherein the optical fibers are disposed in the grooves.

Example 9. The photonic switch assembly of Example 8, further comprising a second guide plate having a plurality of second grooves formed thereon, and wherein the optical fibers are disposed vertically between the first and second grooves.

Example 10. The photonic switch assembly of Example 8, wherein the optical fibers are fixed by a glue layer.

Example 11. The photonic switch assembly of Example 1, wherein the PIC is stacked over a complementary metal-oxide-silicon (CMOS) substrate comprising control circuitry to control optical switching of the PIC.

Example 12. The photonic switch assembly of Example 1, wherein the PIC comprises a first PIC die and a second PIC die stacked on the first PIC die.

Example 13. The photonic switch assembly of Example 1, wherein the fiber substrate comprises a layer stack configured to be bent in response to a temperature change.

Example 14. The photonic switch assembly of Example 13, wherein the layer stack comprises at least two layers having different coefficients of thermal expansion.

Example 15. The photonic switch assembly of Example 9, wherein the fiber substrate comprises a bent layer attached to the first or the second guide plates by an adhesive layer.

Example 16. The photonic switch assembly of Example 15, wherein the bent layer has a coefficient of thermal expansion different from that of the fiber substrate comprises.

Example 17. The photonic switch assembly of Example 1, wherein the PIC comprises an integrated optical switch network.

Example 18. The photonic switch assembly of Example 17, wherein the PIC comprises a microelectromechanical systems (MEMS) optical switch.

### Example Embodiments 3

Example 1. A method of fabricating a photonic switch assembly, the method comprising:
providing a photonic integrated circuit (PIC) comprising an array of optical waveguides formed on a PIC substrate, the optical waveguides terminating with waveguide facets at a side surface of the PIC, wherein the PIC substrate has a first curvature signature;
providing an array of optical fibers disposed on a fiber substrate, the optical fibers terminating with fiber facets;
bending the fiber substrate by applying a force on the fiber substrate to form a bent fiber substrate having a second curvature signature;
disposing the array of optical fibers adjacent to the PIC to align waveguide facets with respective fiber facets,
wherein a magnitude of misalignment between aligned ones of the waveguide facets and the respective optical fiber facets after bending is substantially smaller relative to a reference misalignment between the waveguide facets and the respective optical fiber facets prior to bending the fiber substrate;
securing the bent fiber substrate to a substrate, after bending the fiber substrate, to maintain the second curvature signature in the absence of the force; and
removing the force.

Example 2. The method of Example 1, wherein prior to bending the fiber substrate, pre-aligning the aligned ones of the waveguide facets and the respective optical fiber facets to measure the reference misalignment, wherein the reference misalignment is caused substantially to the first curvature signature.

Example 3. The method of Example 1, wherein the first curvature signature is such that the waveguide facets terminate at positions that are offset relative to nominal terminating positions defined by a reference flat PIC that is the same as the PIC without the first curvature signature.

Example 4. The method of Example 1, wherein the waveguide facets are periodically positioned along an edge of the PIC.

Example 5. The method of Example 2, wherein the fiber substrate comprises an array of grooves, individual grooves configured to capture and secure individual optical fibers.

Example 6. The method of Example 1, wherein the array of optical fibers comprises a plurality of single-mode optical fibers.

Example 7. The method of Example 1, wherein the optical waveguides comprise single-mode waveguides.

Example 8. The method of Example 1, wherein aligning the array of optical fibers with respect to the PIC comprises optically coupling first and second waveguide facets of the PIC to first and second fiber facets of the array of optical fibers.

Example 9. The method of Example 6, wherein aligning the array of optical fibers with respect to the PIC comprises translating one or both the array of optical fibers and the PIC to optically align the first waveguide facet with a core region of the first fiber facet.

Example 10. The method of Example 6, wherein, prior to bending the fiber substrate, a first optical coupling strength between the first waveguide facet and the first fiber facet is at least 10% greater than a second optical coupling strength between the second waveguide facet and the second fiber facet.

Example 11. The method of Example 10, wherein, applying the force on the fiber substrate further comprises applying the force on the fiber substrate to increase one or both the first and second optical coupling strengths.

Example 12. The method of Example 10, wherein, after bending the fiber substrate, wherein a difference between the first and second optical coupling strengths is less than 5%.

Example 13. The method of Example 1, wherein applying the force on the fiber substrate comprises applying a first force on a first position on the fiber substrate and applying a second force on a second location on the fiber substrate.

Example 14. The method of Example 13, wherein applying the first force on the fiber substrate comprises contacting a robotic end effector with the fiber substrate at the first position.

Example 15. The method of Example 13, wherein bending the fiber substrate comprises applying the first force based at least in part on the first curvature signature.

Example 16. The method of Example 13, wherein one or both the first position and magnitude of the first force are determined based at least in part on the first curvature signature.

Example 17. The method of Example 16, wherein bending the fiber substrate further comprises measuring the first curvature signature.

Example 18. The method of Example 1, wherein securing the bent fiber substrate to the fiber substrate comprises curing a UV curable glue provided between the bent fiber substrate and the substrate.

Example 19. The method of Example 1, wherein the substrate comprises the PIC substrate.

Example 20. The method of Example 1, wherein the PIC comprises a first chip connected to a second chip.

Example 21. The method of Example 20, wherein providing the PIC comprises assembling the PIC and bonding the PIC to an electronic substrate.

Example 22. The method of Example 21, wherein bonding the PIC to the electronic substrate comprises flip-chip bonding.

Example 23. The method of Example 21, wherein the first curvature signature is associated with the bonding of the PIC to the electronic substrate.

Example 24. The method of Example 21, wherein the electronic substrate comprises a complementary metal oxide semiconductor (CMOS) electronic circuit.

Example 25. The photonic switch assembly of Example 1, wherein the PIC comprises an integrated optical switch network.

Example 26. The photonic switch assembly of Example 25, wherein the PIC comprises a microelectromechanical systems (MEMS) optical switch.

### Example Embodiments 4

Example 1. A method of fabricating a photonic switch assembly, the method comprising:
providing a photonic integrated circuit (PIC) comprising an array of optical waveguides formed on a PIC substrate, the optical waveguides terminating with waveguide facets at a side surface of the PIC, wherein the PIC substrate has a first curvature signature;
providing an array of optical fibers disposed on a fiber substrate, the optical fibers terminating with fiber facets;
bending the fiber substrate by applying a force on the fiber substrate to form a curved fiber substrate having a second curvature signature;
disposing the array of optical fibers adjacent to the PIC to align waveguide facets with respective fiber facets;
wherein a magnitude of measured transmitted optical power of light transmitted through aligned ones of the waveguide facets and the respective optical fiber facets after bending is substantially higher relative to a reference transmitted optical power of a same light transmitted through the waveguide facets and the respective optical fiber facets prior to bending the fiber substrate;
securing the bent fiber substrate to a substrate, after bending the fiber substrate, to prevent a change in the transmitted optical power in the absence of the force; and
removing the force.

Example 2. The method of Example 1, further comprising, prior to bending the fiber substrate, pre-aligning the aligned ones of the waveguide facets and the respective optical fiber facets to measure the reference optical power, and wherein the aligning the waveguide facets with the respective fiber facets comprises increasing the measured transmitted optical power.

Example 3. The method of Example 1, wherein securing the bent fiber substrate to the substrate the fiber substrate comprises curing a UV curable glue provided between the bent fiber substrate and the substrate.

Example 4. The method of Example 1, wherein aligning the array of optical fibers with respect to the PIC comprises translating the array of optical fibers with respect to the PIC along one or more axes.

Example 5. The method of Example 1, wherein aligning the array of optical fibers with respect to the PIC comprises rotating the array of optical fibers with respect to the PIC around one or more axes.

Example 6. The method of Example 1, wherein bending the fiber substrate comprises applying a force on the fiber substrate.

Example 7. The method of Example 6, wherein bending the fiber substrate further comprises adjusting the force based at least in part on the measured transmitted optical power.

Example 8. The method of Example 1, wherein the substrate comprises the PIC substrate.

Example 9. The method of Example 1, wherein the PIC comprises a first chip connected to a second chip.

Example 10. The method of Example 9, wherein providing the PIC comprises assembling the PIC and bonding the PIC to an electronic substrate.

Example 11. The method of Example 10, wherein bonding the PIC to the electronic substrate comprises flip-chip bonding.

Example 12. The method of Example 10, wherein the first curvature signature is associated with the bonding of the PIC to the electronic substrate.

Example 13. The method of Example 10, wherein the electronic substrate comprises a complementary metal oxide semiconductor (CMOS) electronic circuit.

Example 14. The photonic switch assembly of Example 1, wherein the PIC comprises an integrated optical switch network.

Example 15. The photonic switch assembly of Example 14, wherein the PIC comprises a microelectromechanical systems (MEMS) optical switch.

### Additional Considerations

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

In the embodiments described above, apparatus, systems, and methods for sensing electrical overstress events are described in connection with particular embodiments. It will be understood, however, that the principles and advantages of the embodiments can be used for any other systems, apparatus, or methods with a need for sensing and/or protecting against electrical overstress events.

The principles and advantages described herein can be implemented in various apparatuses. Examples of such apparatuses can include, but are not limited to, consumer electronic products, parts of the consumer electronic products, electronic test equipment, etc. Examples of parts of consumer electronic products can include clocking circuits, analog to digital converts, amplifiers, rectifiers, programmable filters, attenuators, variable frequency circuits, etc. Examples of the electronic devices can also include memory chips, memory modules, circuits of optical networks or other communication networks, and disk driver circuits. Consumer electronic products can include, but are not limited to, wireless devices, a mobile phone (for example, a smart phone), cellular base stations, a telephone, a television, a computer monitor, a computer, a hand-held computer, a tablet computer, a laptop computer, a personal digital assistant (PDA), a microwave, a refrigerator, a stereo system, a cassette recorder or player, a DVD player, a CD player, a digital video recorder (DVR), a VCR, an MP3 player, a radio, a camcorder, a camera, a digital camera, a portable memory chip, a washer, a dryer, a washer/dryer, a copier, a facsimile machine, a scanner, a wrist watch, a smart watch, a clock, a wearable health monitoring device, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

What is claimed is:

1. A photonic switch assembly, comprising:
a photonic integrated circuit (PIC) comprising an array of optical waveguides formed on a PIC substrate, the optical waveguides terminating with waveguide facets at a side surface of the PIC; and
an array of optical fibers disposed on a fiber substrate, the optical fibers terminating with fiber facets optically aligned with the waveguide facets,
wherein the fiber facets and the waveguide facets have an alignment arrangement comprising:
the optical fibers having differently positioned single mode zones such that centroids of the single mode zones have different radial distances from geometric centroids of the fiber facets, and
the centroids of the single mode zones having substantially the same angular displacements relative to a plane corresponding to a major surface of the fiber substrate.

2. The photonic switch assembly of claim 1, wherein the alignment arrangement has an alignment error that is lower by at least a factor of two relative to that of a reference alignment arrangement that is the same as the alignment arrangement, except that the centroids of the single mode zones of the reference alignment arrangement have randomly distributed angular displacements relative to the plane corresponding to the major surface of the fiber substrate.

3. The photonic switch assembly of claim 1, wherein the fiber substrate comprises a first etched guide plate having a first plurality of grooves formed thereon, and wherein the optical fibers are disposed in the first plurality of grooves.

4. The photonic switch assembly of claim 3, further comprising a second guide plate having a second plurality of grooves formed thereon, and wherein the optical fibers are disposed vertically between the first and second pluralities of grooves.

5. The photonic switch assembly of claim 3, wherein the optical fibers are fixed by a glue layer.

6. The photonic switch assembly of claim 1, wherein the PIC substrate has a first curvature signature, and the fiber substrate has a second curvature signature, and wherein the second curvature signature generally tracks the first curvature signature.

7. The photonic switch assembly of claim 6, wherein the alignment arrangement has an alignment error that is lower by at least a factor of two relative to that of a reference alignment arrangement that is the same as the alignment arrangement, except that the fiber substrate does not have the second curvature signature.

8. The photonic switch assembly of claim 6, wherein the fiber substrate comprises a thermal bending stack comprising at least two layers having different coefficients of thermal expansion.

9. The photonic switch assembly of claim 1, wherein the PIC is stacked over a complementary metal-oxide-silicon (CMOS) substrate comprising control circuitry to control optical switching of the PIC.

10. The photonic switch assembly of claim 1, wherein the PIC comprises a first PIC die and a second PIC die stacked on the first PIC die.

11. The photonic switch assembly of claim 1, wherein the PIC comprises a microelectromechanical systems (MEMS) optical switch.

12. A method of fabricating a photonic switch assembly, the method comprising:
providing an optical fiber mount comprising a first optical fiber placed within a first groove of optical fiber mount, the first optical fiber having a first single mode zone;
placing a second optical fiber within a second groove of the optical fiber mount to form an optical fiber array, the second optical fiber having a second single mode zone;
rotating the second optical fiber within the second groove to reduce a vertical offset of a second centroid of the second single mode zone with respect to a first centroid of the first single mode zone; and
securing the second optical fiber to the optical fiber mount to prevent further rotation of the second optical fiber with respect to the optical fiber mount.

13. The method of claim 12, wherein securing the second optical fiber to the optical fiber mount comprises curing a UV curable glue provided between the second groove and the second optical fiber.

14. The method of claim 12, further comprising securing the first optical fiber to the optical fiber mount to prevent further rotation of the first optical fiber with respect to the optical fiber mount.

15. The method of claim 14, further comprising optically aligning the optical fiber array with respect to a photonic integrated circuit (PIC) to optically couple the first and second optical fibers to first and second waveguide facets of the PIC.

16. The method of claim 15, wherein the PIC comprises a microelectromechanical systems (MEMS) optical switch.

17. The method of claim 15, wherein the PIC comprises a bent PIC substrate and optically aligning the optical fiber array with respect to the PIC comprises:
translating one or both the optical fiber array and the PIC to optically align the first and second single mode zones with the first and second waveguide facets;
bending the optical fiber array to form a bent optical fiber array having a curvature matched to that of the bent PIC substrate; and
securing the bent optical fiber array to a substrate, after bending the optical fiber array, to maintain the curvature of the optical fiber array.

18. The method of claim 17, wherein bending the optical fiber array comprises applying a force on the optical fiber mount and securing the bent optical fiber array comprises removing the force.

19. The method of claim 17, wherein bending the optical fiber array comprises changing the temperature of the optical fiber mount.

20. The method of claim 12, further comprising:
placing a third optical fiber having a third single mode zone, having a third centroid, within a third groove;
rotating the third optical fiber within the third groove to reduce a vertical offset of a third centroid with respect to the second centroid; and
securing the third optical fiber to the optical fiber mount to prevent further rotation of the third optical fiber with respect to the optical fiber mount.
